(19) United States
(12) Patent Application Publication
(10) Pub. No.: US 2024/0427868 A1
(43) Pub. Date: Dec. 26, 2024

(54) SYSTEMS AND METHODS FOR SECURE DIGITAL IDENTITY VERIFICATION AND ACCESS TO DISPARATE DATA SOURCES

(71) Applicant: Colorado Department of Law, Denver, CO (US)

(72) Inventors: Thaddeus Batt, Denver, CO (US); Casey Carlson, Denver, CO (US); Olga Klinger, Highlands Ranch, CO (US); Michael Dixon, Lakewood, CO (US); David McCurdy, Centennial, CO (US)

(73) Assignee: Colorado Department of Law, Denver, CO (US)

(21) Appl. No.: 18/822,153

(22) Filed: Aug. 31, 2024

Related U.S. Application Data
(63) Continuation-in-part of application No. 16/949,504, filed on Oct. 30, 2020.
(60) Provisional application No. 62/927,820, filed on Oct. 30, 2019.

(51) Int. Cl. G06F 21/32; G06F 9/54

(52) U.S. Cl. CPC G06F 21/32; G06F 9/547

(57) ABSTRACT

The present disclosure provides a method for secure verification of identities. The method includes obtaining personal identifying information from an individual using a remote device and transmitting the information to an application service. The application service accesses multiple disparate data sources via an API, including public entity data sources, third party data sources, and services sources. The API normalizes data received from the disparate data sources. The personal identifying information is verified against the normalized data. Biometric identifying information is obtained from the individual using the remote device and transmitted to the application service. The biometric identifying information is compared with normalized biometric data from the disparate data sources. Based on the comparison, a determination is made whether to issue a digital identification credential to the individual. An authentication result is transmitted to the remote device.

### RELATED APPLICATIONS

This application claims the benefit of U.S. Provisional Patent Application No. 62/927,820, entitled “OAuth Token Extension for Incorporation of Authoritative Data to Biometry Based Identity Verification,” filed Oct. 30, 2019, and is a continuation-in-part of U.S. Non-Provisional patent application Ser. No. 16/949,504, entitled “Secure Use of Authoritative Data within Biometry Based Digital Identity Authentication and Verification”, filed Oct. 30, 2020, the entire contents of both of which are hereby incorporated by reference herein.

### BACKGROUND

In the digital age, the verification of an individual's identity has become increasingly complex and challenging. Traditional methods of identity verification, such as the use of physical identification cards or documents, are often inadequate in the context of digital interactions. These methods are susceptible to fraud and identity theft, and they do not provide a level of accuracy that is on par with in-person interactions.

Moreover, the use of physical identification credentials often involves manual data entry by the relying party, which can lead to errors and inaccuracies. Furthermore, these credentials often contain outdated or inaccurate information, even after such information has been updated in the issuing authority's database. This can lead to further inaccuracies and inconsistencies in the identity verification process.

In addition to these challenges, there is also a growing demand for a more convenient and efficient means of identity verification. With the increasing prevalence of digital interactions in various sectors, including commerce and law enforcement, there is a pressing need for a digital identification system that is not just secure and accurate, but also easy to use and widely accepted.

Existing technologies and systems for digital identity verification often fall short of these requirements. Many of these systems lack the ability to authoritatively verify the identity of individuals as part of a digital interaction. This limits their usefulness and acceptance, particularly at a state or national level where the stakes for identity verification are high.

Furthermore, existing systems often do not provide a means for individuals to carry and use a digital representation of their identity that is treated as an original ID for purposes of identification. This limits the utility and convenience of these systems for the users.

Therefore, there is a clear and pressing demand for an improved system and method for digital identity verification that addresses these challenges. Such a system would ideally provide a secure, accurate, and convenient means of verifying an individual's identity in a digital interaction and allow for the issuance of a trusted digital ID that can be used within a state or at a national level.

### SUMMARY OF INVENTION

According to an aspect of the present disclosure, a method for secure verification of identities is provided. The method includes receiving, at an application services computation and storage environment, personal identifying information for a first user from a user device. The method also includes receiving, from an authoritative government issued ID data repository, official government identification information for the first user. The method further includes processing, at the application services computation and storage environment, to determine if the personal identifying information matches the official government identification information. Additionally, the method includes analyzing, by the application services computation and storage environment, a match score to determine whether to issue a digital identification credential to the individual.

According to other aspects of the present disclosure, the method may include one or more of the following features. The personal identifying information may include a first user biometric identifying information captured by the user device. The personal identifying information may include at least one of a name, address, date of birth, driver license data, state and/or national identification data, passport data, height data, weight data, and a social security number. The biometric identifying information may include one or more of a facial image captured by a camera of the user device and a fingerprint captured by a fingerprint scanner of the user device.

The method may further include receiving the first user biometric identifying information at the application services environment from the user device, processing the first user biometric identifying information and the first user official government identification information at a biometric analysis engine to perform one or both of statistical identity proofing and verification services, and generating the match score via a closeness match between the first user biometric identifying information and the first user official government identification information. The authoritative government issued ID data repository may be maintained by a state government entity. The digital identification credential may be associated with a digital driver license.

According to another aspect of the present disclosure, a system for secure verification of identities is provided. The system includes an application services computation and storage environment configured to receive a first user personal identifying information and a biometric identifying information from a user device, receive authoritative personal information from an authoritative government issued ID data repository, process the personal identifying information and authoritative personal information to generate a match score identifying a closeness match between the personal identifying information and the authoritative personal information in a data record in said authoritative government issued ID data repository, and determine if the match score is above a threshold to determine whether to issue a digital identification credential to the first user.

According to other aspects of the present disclosure, the system may include one or more of the following features. The user device may be a mobile device. The personal identifying information may include at least one of a name, address, date of birth, driver license data, state and/or national identification data, passport data, height data, weight data, and a social security number. The biometric identifying information may include one or more of a facial image captured by a camera of the user device, a fingerprint captured by a fingerprint scanner of the user device, an eye scan captured by a camera of the user device, and user movement captured by one or both of a camera and an accelerometer of the user device.

The application services computation and storage environment may access the authoritative government issued ID data repository via an Application Programming Interface (API) which configures the request for the authoritative personal information such that the request complies with the authoritative government issued ID data repository systems and normalizes the returned data such that it may be used by the application services computation and storage environment and its users. The authoritative government issued ID data repository may be maintained by a state government entity. The digital identification credential may be a digital driver license.

According to another aspect of the present disclosure, a method for secure verification of identities is provided. The method includes receiving a first user's personal identifying information at an application service, accessing, by the application service via an API, two or more domains within one or more disparate data sources to retrieve official government identification information for the first user, and normalizing, by said API, official government identification information for the first user received from said disparate data sources for use by said application service. The method also includes verifying said personal identifying information against normalized official government identification information for the first user from said disparate data sources, receiving biometric identifying information from the first user using a first user device, comparing said biometric identifying information with normalized official government identification information for the first user from one or more of the disparate data sources, and determining, based on said comparing, whether to issue a digital identification credential to said individual.

According to other aspects of the present disclosure, the method may include one or more of the following features. The method may further include generating, by a relying party device, a QR code for a unique request, scanning said QR code by the first user device, and processing said QR code for authentication. The disparate data sources may include at least one authoritative government issued ID data repository. The method may further include creating a digital wallet for one or both of the first user and the relying party, and storing said digital identification credential in the digital wallet.

The method may also include receiving a request from a relying party for first user data, processing said request by said application service, accessing, via said API, relevant data from one or more disparate data sources based on the details of the request and the level of access by the relying party, and transmitting a response to said relying party including the relevant data. The method may further include obtaining user consent before accessing the relevant data. Normalizing may include one or both of standardizing data formats and resolving inconsistencies between data from different sources. The method may include updating said digital identification credential in real-time based on changes in data from one or more disparate data sources. The digital identification credential may include at least one of a digital driver license, a digital passport, and a digital government-issued identification card. The method may further include establishing an authenticated session between the first user device and the relying party device based on an authentication result.

According to another aspect of the present disclosure, a method for updating a digital wallet is provided. The method includes obtaining, by an application service computation and storage environment, user account information associated with an individual, accessing, via an API, multiple disparate data sources including domains within one or more of public entity data sources, third party data sources, and services sources, and retrieving, by the API, updated user data from the disparate data sources. The method also includes normalizing, by the API, the updated user data for use by the application service computation and storage environment, updating, at the application service computation and storage environment, a user account wallet associated with the individual based on the normalized updated user data, and transmitting the updated user account wallet information to a remote device associated with the individual.

According to other aspects of the present disclosure, the method may include one or more of the following features. The method may further include receiving, by the application service computation and storage environment, a request from the remote device to update the wallet application, verifying the identity of the individual before transmitting the updated user account wallet information, and encrypting the updated user account wallet information before transmission to the remote device.

According to another aspect of the present disclosure, a method for real-time wallet updates is provided. The method includes establishing a connection between a remote device and an application service computation and storage environment, monitoring, by the application service computation and storage environment via an API, multiple disparate data sources for changes in user-related data, and detecting a change in user-related data in at least one of the disparate data sources. The method also includes retrieving the changed user-related data via the API, normalizing the retrieved data for use by the application service computation and storage environment, updating, at the application service computation and storage environment, a user account wallet based on the normalized data, generating an update notification, and transmitting the update notification and updated wallet information to the remote device.

According to other aspects of the present disclosure, the disparate data sources may include at least one of a driver license database, a vehicle registration database, a hunting and fishing license database, a professional certification database, and a medical record database.

According to another aspect of the present disclosure, a method for wallet creation and management is provided. The method includes receiving, by an application service computation and storage environment, a request to create a digital wallet for an individual, accessing, via an API, multiple disparate data sources to retrieve user-related data, and normalizing the retrieved user-related data. The method also includes creating a user account wallet based on the normalized user-related data, generating a digital identification credential based on the normalized user-related data, storing the digital identification credential in the user account wallet, transmitting the user account wallet and digital identification credential to a remote device associated with the individual, and periodically updating the user account wallet and digital identification credential based on changes detected in the disparate data sources.

According to other aspects of the present disclosure, the method may further include applying artificial intelligence techniques to analyze the normalized user-related data, and identifying potential services or renewals based on the analysis.

According to another aspect of the present disclosure, a method for secure wallet updates is provided. The method includes receiving, by an application service computation and storage environment, a request from a remote device to update a wallet application, authenticating the request using multi-factor authentication, and upon successful authentication, accessing multiple disparate data sources via an API to retrieve current user data. The method also includes normalizing the retrieved current user data, comparing the normalized current user data with existing data in a user account wallet, identifying discrepancies between the normalized current user data and the existing data, updating the user account wallet based on the identified discrepancies, generating an update package for the wallet application on the remote device, and securely transmitting the update package to the remote device.

According to other aspects of the present disclosure, the multi-factor authentication may include at least two of biometric verification, knowledge-based authentication, and possession-based authentication.

According to another aspect of the present disclosure, a method for consent-based wallet updates is provided. The method includes detecting, by an application service computation and storage environment, a change in user-related data in at least one of multiple disparate data sources, retrieving the changed user-related data via an API, and normalizing the retrieved data for use by the application service computation and storage environment and its users. The method also includes identifying potential updates to a user account wallet based on the normalized data, generating a consent request detailing the potential updates, transmitting the consent request to a remote device associated with the user, receiving a response to the consent request from the remote device, updating the user account wallet based on the received response, and if consent is granted, transmitting the updates to a wallet application on the remote device.

According to other aspects of the present disclosure, the method may further include maintaining a log of all consent requests, responses, and subsequent updates to the user account wallet.

According to another aspect of the present disclosure, a method for creating a digital wallet is provided. The method includes obtaining, by an application service computation and storage environment, initial user account information associated with an individual, accessing, via an API, at least one data domain in one or more disparate data sources, and retrieving, by the API, user data from the at least one data domain. The method also includes normalizing, by the API, the user data for use by the application service and its associated user devices, creating, within the application service computation and storage environment, a user account wallet associated with the individual based on the normalized user data, transmitting the user account wallet information to an associated remote user device associated with the individual, and initializing a wallet application on the remote device with the user account wallet information.

According to other aspects of the present disclosure, the method may further include receiving, by the application service computation and storage environment, a request from the remote device to create the wallet application, verifying the identity of the individual at least by comparing data collected from the remote device and normalized data derived from at least one domain before transmitting the user account wallet information, and encrypting the user account wallet information before transmission to the remote device.

According to another aspect of the present disclosure, a method for initial wallet creation is provided. The method includes establishing a connection between a remote device and an application service computation and storage environment, accessing, by the application service computation and storage environment via an API, multiple disparate data sources for initial user-related data, and retrieving the initial user-related data via the API. The method also includes normalizing the retrieved data for use by the application service computation and storage environment, creating a user account wallet based on the normalized data, generating an initialization notification, and transmitting the initialization notification and initial wallet information to the remote device.

According to other aspects of the present disclosure, the disparate data sources may include at least one of a driver license database, a vehicle registration database, a hunting and fishing license database, a professional certification database, or a medical record database.

According to another aspect of the present disclosure, a method for secure verification of identities is provided. The method includes generating, by a relying party, a QR code for a unique request, scanning, by a remote device, the QR code, and processing the QR code for authentication. The method also includes sending a user ID authentication request from an application user interface to a verification engine, authenticating, by the verification engine, the user ID, and transmitting an authentication response from the verification engine to the application user interface. The method further includes processing the authentication response by the application user interface, sending a request from the relying party to an API, forwarding the request from the API to a public entity data source, processing the request by the public entity data source, and transmitting a response from the public entity data source to the API.

According to other aspects of the present disclosure, the method may further include sending an optional request from the relying party to a user account to update or retrieve additional data, and receiving an optional response from the user account. The remote device may be a mobile device. The QR code may contain information specific to the relying party. The user ID authentication request may include biometric data. The public entity data source may be a government database.

According to another aspect of the present disclosure, a method for secure identity verification is provided. The method includes generating a unique request QR code, scanning the QR code with a remote device, and processing the scanned QR code for authentication. The method also includes transmitting a user ID authentication request to a verification engine, authenticating the user ID by the verification engine, and sending an authentication response to an application user interface. The method further includes processing the authentication response, transmitting a data request from a relying party to an API, forwarding the data request to a public entity data source, processing the data request by the public entity data source, and sending a response from the public entity data source to the API.

According to other aspects of the present disclosure, the method may further include transmitting an optional request to update or retrieve additional data from a user account, and receiving an optional response from the user account. The verification engine may be part of a credential service provider. The public entity data source may be selected from a group consisting of a driver license database, a vehicle registration database, and a professional certification database.

The present disclosure also contemplates additional embodiments that are broader than those described in the claims. For example, the system and methods described herein may be applied to various types of digital identification credentials beyond driver licenses, such as passports, state ID cards, national ID cards, or professional certifications. The system may also incorporate additional biometric data types for verification, such as voice recognition or gait analysis. Furthermore, the system could be expanded to include integration with blockchain technology for enhanced security and transparency in identity verification processes.

### BRIEF DESCRIPTION OF FIGURES

FIG. 1 illustrates a system diagram for secure use of consent-based authoritative data within biometry based digital identity authentication and verification, in an embodiment.

FIG. 2 illustrates a flowchart for a method of secure identity verification and digital ID provisioning, in an embodiment.

FIG. 3 illustrates an authentication logic diagram for a system of secure identity verification, in an embodiment.

FIG. 4A illustrates a logical diagram of an application, application server, and security functions for a system of secure identity verification, in an embodiment.

FIG. 4B illustrates a system diagram for an application service with API access to multiple disparate data sources and domains, in an embodiment.

FIG. 5A illustrates a system diagram of remotely located components for secure use of consent-based authoritative data within biometry based digital identity authentication and verification, in an embodiment.

FIG. 5B illustrates a system diagram for additional security and non-ID data processing, in an embodiment.

FIG. 6 illustrates a method for an account setup process, in an embodiment.

FIG. 7 illustrates a system diagram for unique request and verification of a user for a replying entity, in an embodiment.

FIG. 8 illustrates a system diagram for verification of a user for a replying entity, in an embodiment.

FIG. 9 illustrates a method for verification of a user for a replying entity, in an embodiment.

FIG. 10 illustrates a system for user data and domain data access after verification, in an embodiment.

FIG. 11 illustrates a system for wallet creation and management using consent-based authoritative data, in an embodiment.

FIG. 12 shows a communication flow for verifying a relying party and domain of access via an application service, in an embodiment.

FIG. 13 shows a communication flow for verifying a relying party and domain of access via a user equipment app, in an embodiment.

FIG. 14 shows a communication flow of a relying party domain of access process, in an embodiment.

FIG. 15 shows a communication flow for a relying party request and response process involving user ID data, in an embodiment.

FIG. 16 shows a communication flow for secure use of consent-based authoritative data within biometry based digital identity authentication and verification, in an embodiment.

FIG. 17 shows a communication flow for a relying party request and response process with user authentication, in an embodiment.

### DEFINITIONS

“API” means Application Programming Interface, which is a set of protocols, routines, and tools for building software applications that specifies how software components should interact. APIs define the methods and data structures that applications can use to request and exchange information. They serve as a software intermediary that allows two applications to communicate with each other, enabling developers to integrate different software systems and services.

“Authoritative data repository” means a trusted source of official records or data used for identity verification, typically maintained by a government entity or other authorized body. These repositories contain verified and reliable information that can be used to validate an individual's identity or credentials. Authoritative data repositories play a crucial role in maintaining data integrity and ensuring the accuracy of identity verification processes.

“Biometric identifying information” means unique physical characteristics of an individual that can be used for identification, such as facial features, fingerprints, or retinal patterns. These biological traits are measurable and can be used to establish or verify an individual's identity with a high degree of accuracy. Biometric identifying information is increasingly used in security systems and identity verification processes due to its uniqueness and difficulty to forge or replicate.

“Digital identification credential” means an electronic form of identification that can be used to verify an individual's identity in digital interactions. These credentials may include digital versions of traditional identification documents, such as driver's licenses or passports, as well as other forms of electronic identity verification. Digital identification credentials offer enhanced security features and can be easily updated, making them increasingly important in our digital-first world.

“Disparate data sources” means multiple, separate databases or information systems that may contain different types of data in various formats. These sources often exist in isolation from each other, potentially leading to data silos within organizations. Integrating and harmonizing data from disparate sources can provide a more comprehensive view of information and enable more effective decision-making processes.

“Identity verification” means the process of confirming that an individual is who they claim to be. This process typically involves comparing provided information against trusted sources or records to establish the authenticity of an individual's claimed identity. Identity verification is crucial in many contexts, including financial transactions, access control, and legal proceedings, to prevent fraud and ensure security.

“Normalizing data” means the process of organizing and standardizing data from different sources into a consistent format. This process involves eliminating redundancies, resolving inconsistencies, and structuring data in a way that makes it easier to use and analyze. Normalized data is essential for effective data integration, accurate reporting, and efficient data management across various systems and applications.

“OAuth2” means an open standard for access delegation, commonly used as a way for internet users to grant websites or applications access to their information on other websites but without giving them the passwords. This protocol allows third-party applications to obtain limited access to a user's account on an HTTP service. OAuth2 improves security by eliminating the need for users to share their credentials with multiple services, reducing the risk of unauthorized access.

“OIDC” means OpenID Connect, which is an authentication layer on top of OAuth2.0, an authorization framework. OIDC extends OAuth2.0 to provide a standardized way for clients to verify the identity of end-users based on the authentication performed by an authorization server. It allows clients of all types, including web-based, mobile, and JavaScript clients, to request and receive information about authenticated sessions and end-users.

“Personal identifying information” means any data that can be used to identify a specific individual, such as name, address, date of birth, or social security number. This information is often sensitive and requires careful handling to protect individual privacy and prevent identity theft. Personal identifying information is subject to various data protection regulations and must be collected, stored, and processed in compliance with applicable laws and best practices.

“Relying party” means an entity that depends on the identity verification system to authenticate individuals for its own purposes. These entities rely on the assurances provided by the identity verification system to make decisions about granting access, providing services, or engaging in transactions with individuals. Relying parties may include businesses, government agencies, or other organizations that need to verify the identity of individuals they interact with.

“Remote device” means a device such as a smartphone, tablet, or computer that is used by an individual to interact with the identity verification system. These devices serve as the user interface for accessing and utilizing identity verification services. Remote devices play a crucial role in modern identity verification systems, enabling users to authenticate themselves and access services from virtually anywhere with an internet connection.

“User consent” means explicit permission given by a user for their personal data to be collected, used, or shared in specific ways. This concept is fundamental to data privacy and protection regulations, ensuring that individuals have control over their personal information. User consent is typically obtained through clear and transparent communication about how data will be used, often requiring affirmative action from the user to indicate their agreement.

### DETAILED DESCRIPTION

The present disclosure relates to a secure identity verification system that leverages a combination of user devices, application services environments, authoritative government ID repositories, and biometric analysis services to authenticate individuals and issue digital credentials. This system is designed to facilitate secure digital interactions by verifying the identities of individuals with a level of accuracy that is on par or superior to in-person interactions.

The system is unique in its ability to access and integrate data from multiple disparate sources, including various public or government entities such as the Department of Motor Vehicles (DMV), Department of Parks and Wildlife, Department of Human Services, Department of Transportation, Department of Education, Federal Aviation Administration (FAA), and others. It can also interface with third-party data sources like CLEAR for travel, pharmacies, parking companies, UBER, and more. Additionally, the system can tap into service data sources such as the Supplemental Nutrition Assistance Program (SNAP), license and permit renewals, Colorado Child Care Assistance Program (CCCAP), Nurse-Family Partnership, Colorado WIC, Medicaid, Behavioral Health Administration Community Services, Child Health Plan (CHP+), and others.

The system's ability to access and integrate data from these diverse sources enables it to provide a comprehensive and accurate verification of an individual's identity, provide access to services, and provide access to third-party products and services. This is achieved by extending the OAuth2 standard to securely deliver a payload of governmental authoritative biometric data, which is then used by an Identity Verification service to perform a biometric analysis.

Furthermore, the system provides a mechanism for relying parties (e.g., a police officer, a pharmacist, a medical provider, a parks ranger, etc.) to request data and information from a user through the creation and use of a real-time generated unique data request package, such as but not limited to, a unique data request in the form of a Quick Response (QR) code. This feature enhances the system's versatility and applicability across a wide range of scenarios where secure identity verification is required.

In summary, the present disclosure provides a robust and secure system for identity verification, access to data from disparate sources, a single point of up-to-date information originating from disparate sources, and secure and consent based access to data that leverages a wide range of data sources, advanced biometric analysis techniques, and previously inaccessible authoritative identity databases to authenticate individuals and relying parties, issue digital credentials, and provide and/or limit access to data.

As described with reference to some of the accompanying figures, some aspects of the systems and methods provide a digital identification credential allowing the issuance of a digital identification credential to an individual and/or relying party. Such an entity is referred to herein as a digital credential issuing entity. The present invention allows a digital credential issuing entity to issue a digital identification credential that is authentic, trustworthy, and accurate, and that has been verified in accordance with industry compliance standards and best practices. The digital identification credential systems and methods increase the likelihood that relying parties will be able to accurately identify individuals while protecting individuals' privacy and reducing instances of identity theft.

As used in this application, the terms “device,” “computer,” “service,” “system,” “interface,” “server,” “computational environment”, “computational and storage environment”, or the like are generally intended to refer to a computer-related entity, either hardware, a combination of hardware and software, software, or software in execution or an entity related to an operational machine with one or more specific functionalities. For example, a service may be, but is not limited to being, a process running on a processor, a processor, an object, an executable, a thread of execution, computer-executable instruction(s), a program, and/or a computer.

Further, the various embodiments can be implemented as a system, a method, an apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. Of course, those skilled in the art will recognize many modifications can be made to this configuration without departing from the scope or spirit of the various embodiments.

The present invention may be implemented in compliance with digital identity guidelines issued by governmental entities, such as the National Institute of Standards and Technology's SP-800-63 Digital Identity Guidelines document suite, which is hereby incorporated by reference, and any additional and successor digital identity guidelines.

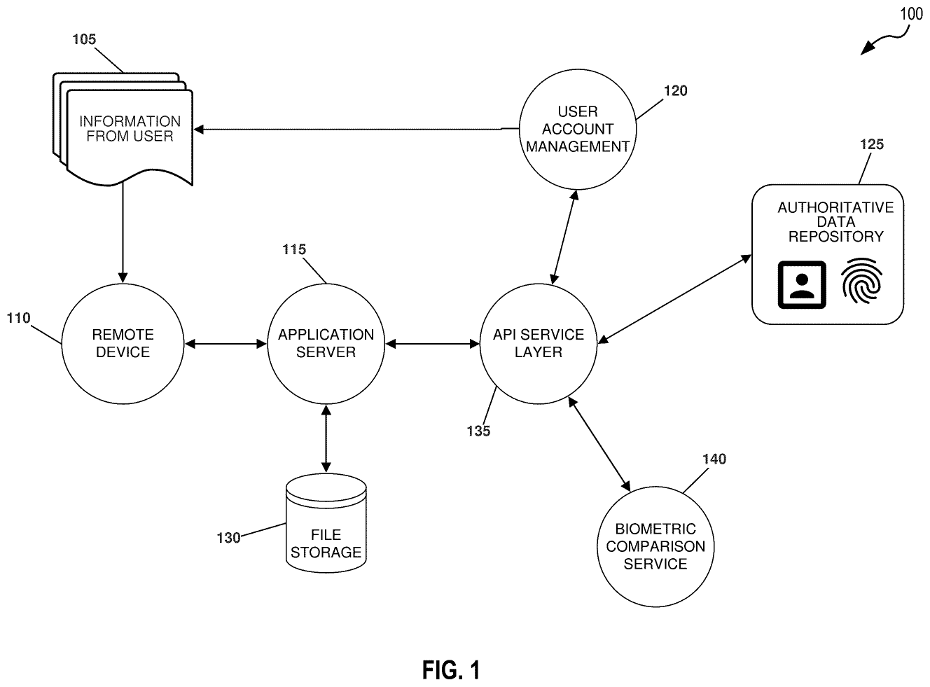

FIG. 1 shows a computer system including one or more servers or similar computing devices, and a remote device 110 on which an individual's digital identification credential is stored. The remote device 110 (also called herein a user device 110 and a UE 110) is a device including a processor and memory that stores executable instructions that, when executed by the processor, facilitate performance of operations. The remote device 110 could be a phone, tablet, computer, or other device, including software, which could be a software application, app, website, or other interface. The application server 115 is a server device including a processor and memory that stores executable instructions that, when executed by the processor, facilitate performance of operations.

FIG. 1 illustrates a system diagram 100 for secure verification of identities. The system includes a user device, which may be one aspect of remote device 110, which may be used to obtain personal identifying information and biometric identifying information from an individual. This information is transmitted to a remote device 110, which may be a mobile device or computer used by the individual. The remote device 110 then communicates with an application services environment, represented by the application server 115.

The application server 115 interacts with several key components to process and verify the received information. These components include user account management 120, which may handle user registration and authentication processes; an authoritative data repository 125, which may contain official records or data used for identity verification; and a temporary data storage 130, which may be used for caching data during the verification process. The system also incorporates an API service layer 135, which may facilitate communication between various components of the system, and a biometric comparison service 140, which may perform comparisons of biometric data.

In operation, the application server 115 may transmit personal identifying information to the authoritative data repository 125 and receive a response indicating whether the information matches authoritative personal information in a data record. The system may also involve transmitting biometric identifying information to the biometric comparison service 140 and receiving a match score. The application server 115 may analyze this match score to determine whether to issue a digital identification credential to the individual. This multi-layered approach to identity verification combines personal information, authoritative data, and biometric comparisons to ensure secure and accurate authentication.

A remote device 110 communicates either directly or indirectly with an application server 115 to receive and transmit information related to the remote device 110 and its environment, and information provided by the individual using the remote device 110. An application server 115 communicates either directly or indirectly with a remote device 110 and a plurality of servers and other computing devices through a variety of methods including the use of application programming interfaces, which may be organized as a plurality of application programming interfaces referred to herein as an “API service layer” 135.

It is envisioned that the system of the present invention can be implemented on any existing or future devices with the processing capability to perform the functions described herein. The scope of the present invention is not limited by the types of devices used. One skilled in the art will recognize that connections to external or internal network systems are merely exemplary, and alternative embodiments may have other connections.

The remote device 110 prompts an individual to provide permission for the remote device 110 to collect various forms of data, including personal identifying information and biometric identifying information. The individual responds by tapping the screen 105 or using any other input method provided by the remote device 110. The remote device 110 prompts the individual to provide, and collects from the individual 205, one or more pieces of personal identifying information 105 using an input method available through the use of the remote device 110, such as a camera, keyboard, or voice interaction. The personal identifying information 105 may include one or more pieces of information known by the individual or contained on one or more identification credentials possessed by the individual, such as a visual or alphanumeric code, identification number, name, or other information. Personal identifying information 105 from the individual may include the name, address, email address, telephone number, a plurality of digits from the individual's social security number, or other information provided by the individual.

The remote device 110 transmits 210 the personal identifying information 105 to the application server 115. The application server 115 may cache the personal identifying information in file storage 130 for processing. The application server 115 transmits one or more pieces of personal identifying information or biometric identifying information collected from the individual to an authoritative data repository 125.

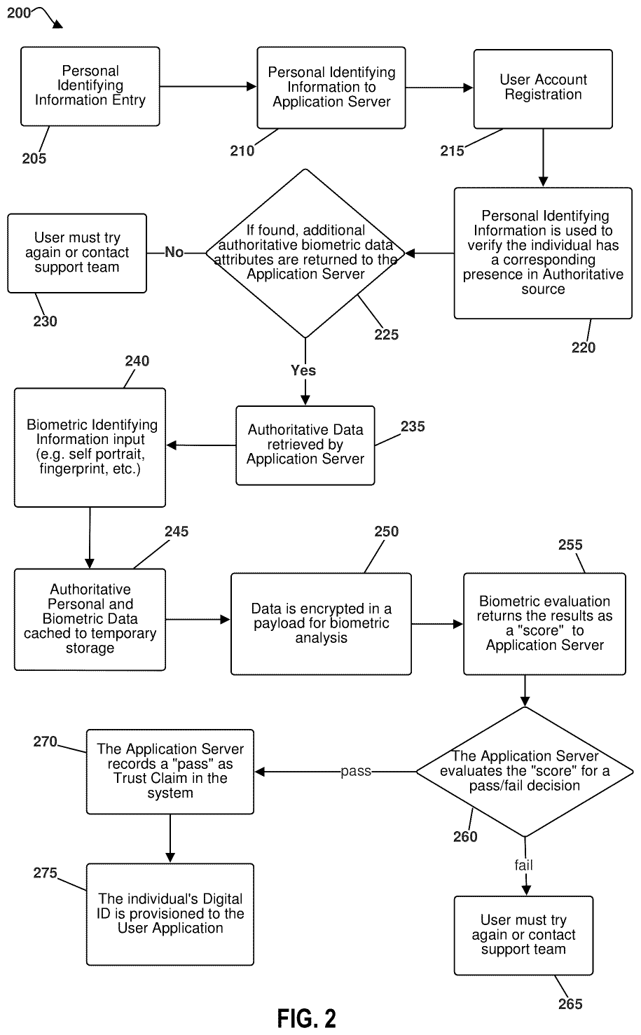

Referring now to FIG. 2, The authoritative data repository 125 compares 220 the personal identifying information or biometric identifying information received from the application server 115 to data records in the authoritative data repository 125. If the authoritative data repository 125 identifies a match 225 between the data received from the application server 115 and a data record contained in the authoritative data repository 125, the authoritative data repository 125 transmits 235 to the application server 115 a response indicating that a match was found, and may also transmit 225 to the application server 115 authoritative identifying information from the matching data record, which may include authoritative personal information such as a driver license number and physical characteristics, or authoritative biometric information such as an authoritative photograph, fingerprint, or retinal scan. If the authoritative data source does not find a match, the individual is prompted to try again or contact customer support 230.

The application server 115 causes an account to be created 215 in user account management 120 for an individual who does not already have an account, or accesses an account in user account management 120 already associated with that individual. As a part of the account creation process user account management 120 may send a one-time verification code to the individual, which may be sent to the remote device 110 or another device or account, that the individual must input 105 into remote device 110 to confirm that the individual has access to a mobile phone number, email address, or other device or account that was provided by the individual to the remote device 110 as part of the account creation process or that is otherwise specified in the user account.

The remote device 110 requests that the individual use one or more input devices available through the use of the remote device 110, such as a camera, fingerprint reader, retinal scanner, etc. in a manner that allows the remote device 110 to create a self-portrait of the individual or obtain other biometric identifying information of the individual, such as a fingerprint or a retinal scan. The remote device 110 collects 240 and transmits biometric identifying information collected from the individual to the application server 115. The application server 115 may cache 245 the information in temporary storage. The remote device 110 may also transmit to the application server 115 information related to the remote device 110, which may include the brand, model, device identifier, operating system, and other information about the remote device 110. The remote device 110 may also transmit to the application server 115 information related to the environment of the remote device 110, which may include the time, date, IP address, physical location, and other information about the environment in which the remote device 110 is being used.

The application server 115 transmits 250 the authoritative biometric information and the biometric identifying data to a biometric comparison service 140. The biometric comparison service 140 may be connected either directly or indirectly to the application server 115 and may be a service on a different server or computing device. The biometric comparison service 140 analyzes and compares the biometric identifying data and the authoritative biometric information to determine whether the two data elements were obtained from the same individual, and calculates a match score from that analysis. One skilled in the art understands that the criteria for determining whether the match score is sufficiently high to authorize the issuance of a digital identification credential can be customized by the digital credential issuing entity. The biometric comparison service 140 transmits 255 the match score to the application server 115.

The application server analyzes 260 the match score. If the results of applying the criteria to the match score indicates that the authoritative biometric information and the biometric identifying information does not identify the same individual 265, the application server transmits a message to the remote device indicating that the individual must try again or contact customer support. If the results of applying the criteria to the match score indicates that the authoritative biometric information and the biometric identifying information identify the same individual 270, the application server 115 transmits authoritative identifying information and a message indicating that a valid authenticated digital identification credential has been issued to the remote device 110 and provisions 275 a digital identification credential to the remote device 110. The remote device 110 stores authoritative identifying information in a secure location on the remote device 110. The individual can then access the authoritative identifying information on the remote device 110. The individual accesses that information by supplying login credentials to the remote device 110 using an input method provided by the remote device 110. If the remote device 110 determines that the login credentials entered by the individual match the login credentials stored in the remote device 110, the remote device 110 allows the individual to access the individual's authoritative identifying information, one manifestation of which may be a verified and authenticated digital identification credential.

Referring generically to FIG. 2, method 200 shows a secure verification of identity process.

The method 200 begins with a user information entry step 205. In this step, personal identifying information is obtained from an individual using a user device, which may be a mobile device, a computer, or any other device capable of receiving user input.

Personal identifying information may include an individual's full legal name, current residential address, date of birth, government-issued identification numbers such as a driver license number or passport number, state and/or national identification number, and social security number. In some cases, it may also encompass an individual's phone number, email address, place of birth, mother's maiden name, or other unique identifiers that can be used to distinguish one person from another. Additionally, personal identifying information may include physical characteristics such as height, weight, eye color, and hair color, which are often recorded on government-issued identification documents.

Following the user information entry step 205, the method 200 proceeds to a step of sending user information to the server 210. In this step, the personal identifying information obtained from the individual is transmitted from the user device to an application services environment.

Next, the method 200 includes a user registration step 215. During this step, the application services environment creates a user account based on the personal identifying information received from the user device.

The method 200 may also include a step of obtaining biometric identifying information from the individual using the user device. This biometric identifying information may include a facial image, a fingerprint, a retinal scan, or any other biometric data that can be used to uniquely identify the individual.

In addition to facial images, fingerprints, and retinal scans, the biometric identifying information obtained by the remote device may include voice patterns, iris scans, palm prints, hand geometry, ear shape, keystroke dynamics, gait analysis, or vein patterns. The remote device may also capture behavioral biometrics such as signature dynamics, mouse use patterns, or touchscreen interaction patterns. In some cases, the device may be capable of obtaining less common biometric data like heart rhythm patterns. Some of this biometric data may be obtained via the remote device or by an associated device such as a smart watch, wearable IoT device, a smart pen, etc.

In a verification step 220, the personal identifying information is used to verify the individual's data present in an authoritative source.

The verification process is conducted by comparing the personal identifying information received from the application server to data records stored in the authoritative data repository. The authoritative data repository examines the received information and searches for a match within its records. If a match is found between the received data and a data record in the authoritative data repository, the repository sends a response to the application server indicating that a match was found. Additionally, the authoritative data repository may transmit authoritative identifying information from the matching data record to the application server, which may include authoritative personal information such as a driver license number and physical characteristics. In cases where no match is found in the authoritative data source, the system prompts the individual to either try the process again or contact customer support for assistance.

A decision step 225 determines if additional authoritative biometric data attributes are found and returned to the application server.

The decision step 225 specifically focuses on determining if authoritative biometric data exists in the authoritative data repository. In this step, the system checks whether the authoritative data repository contains biometric data attributes associated with the matched record.

If authoritative biometric data is found, the method 200 continues to a retrieve authoritative biometric data step 235.

In step 240, biometric identifying information is received as an input. A caching step 245 involves caching authoritative personal and biometric data to temporary storage.

The personal identifying information (PII) data is only stored temporarily for several important reasons. In some aspects, temporary storage of PII data may enhance security and privacy protection. By caching the data only for the duration necessary to complete the verification process, the system reduces the risk of unauthorized access or data breaches. Once the verification is complete, the temporary data can be securely deleted, minimizing the potential exposure of sensitive personal information.

Additionally, temporary storage may help comply with data protection regulations and best practices. Many privacy laws require organizations to limit data retention to the minimum necessary period for fulfilling the intended purpose. By storing PII data only temporarily, the system may better adhere to these principles of data minimization and purpose limitation.

In some cases, temporary storage may also improve system performance and efficiency. Caching the data locally for a short period can allow for faster processing and comparison during the verification steps, potentially reducing latency and improving the user experience. Once the verification is complete, the temporary data can be cleared to free up system resources.

Furthermore, temporary storage may facilitate real-time verification without the need for long-term data retention. This approach allows the system to perform necessary comparisons and authentications using the most up-to-date information from authoritative sources, while avoiding the risks associated with maintaining a persistent database of sensitive personal data.

An optional encryption step 250 may follow, where data is encrypted in a payload for biometric analysis.

The data may be encrypted prior to sending for biometric comparison for several important reasons. In some aspects, encryption of biometric data before transmission enhances the overall security and privacy of the system. By encrypting the data, even if it is intercepted during transmission, the sensitive biometric information remains protected and unreadable to unauthorized parties. This encryption step may help safeguard against potential data breaches or man-in-the-middle attacks.

Additionally, encrypting the biometric data may help ensure compliance with various data protection regulations and industry standards. Many privacy laws and guidelines require the implementation of strong security measures when handling sensitive personal data, especially biometric information. Encryption may be considered a best practice for protecting such data during transmission.

In some cases, encryption may also provide an additional layer of authentication and integrity verification. By using specific encryption keys or protocols, the biometric comparison service can verify that the data it receives is genuine and has not been tampered with during transmission. This may help prevent spoofing attacks or the submission of fraudulent biometric data.

Furthermore, encryption may allow for secure transmission of biometric data across different networks or between separate systems. This can be particularly important if the biometric comparison service is hosted on a different server or operated by a third-party provider. Encryption helps maintain the confidentiality of the data as it moves between these different components of the system.

Encrypting the biometric data before transmission may also demonstrate a commitment to user privacy and data protection. This practice may help build trust with users who are sharing sensitive biometric information, assuring them that their data is being handled with appropriate security measures at every stage of the process.

A biometric scoring step 255 then occurs, returning results as a “match score” to the application server.

A biometric comparison service may generate a match score through various methods, depending on the type of biometric data being compared and the specific algorithms employed. In some aspects, the match score may be calculated by comparing the similarity between the biometric identifying information provided by the user and the authoritative biometric data retrieved from the authoritative data repository. In some embodiments the match score is based on more than one biometric comparison, for example, the match score may be based on two or more of the previously described biometric identifying information types (e.g., facial recognition, voice recognition, iris scan, fingerprint, gait recognition, etc.) thereby increasing security and confidence in the match score.

For facial recognition, the system may analyze key facial features and their spatial relationships, generating a numerical representation of the face. This representation may then be compared to the authoritative facial data, with the degree of similarity expressed as a match score. The score may be influenced by factors such as the number of matching facial points, the quality of the images being compared, and the consistency of facial features across different angles or expressions.

In the case of fingerprint comparison, the match score may be based on the number and quality of matching minutiae points between the provided fingerprint and the authoritative fingerprint data. The system may also consider the overall pattern of the fingerprint and the clarity of the ridge details in determining the score.

For other biometric data types, such as voice patterns or iris scans, similar principles may apply. The system may extract unique features from the provided biometric data and compare them to the corresponding features in the authoritative data, generating a match score based on the degree of similarity.

In some implementations, the match score may be normalized to a scale (e.g., 0-100 or 0-1) to facilitate consistent interpretation across different biometric modalities. The system may also employ machine learning algorithms to refine the scoring process over time, potentially improving the accuracy and reliability of the match scores and may take into account biometric data that drifts over time, such as how aging can affect facial recognition or gait recognition. Scalar/weighting values may also be applied to match scores based on the confidence associated with the type of biometric data being compared and the comparison algorithm use. Some weighting values may decrease the match score if the type of biometric data compared, or the algorithm used, is known to have less than ideal accuracy. Other weighting values may increase the match score if the type of biometric data being compared, or the algorithm used is known to be high quality. Otherwise, a weighting factor of 1 may be used, resulting in no change to the original match score or scores. Weighting factors can be particularly useful when the final match score is the result of a plurality of biometric comparisons.

It's important to note that the generation of match scores may involve complex statistical and probabilistic models, and the specific methods used may vary depending on the biometric comparison service employed and the requirements of the digital credential issuing entity.

The application services environment then proceeds to analyze the match score in the decision step 260.

The analysis of the match score in decision step 260 is a crucial part of the identity verification process. This step determines whether the biometric data provided by the user matches closely enough with the authoritative biometric data to confirm the user's identity.

In some aspects, the system may employ a threshold-based approach to determine if the match is sufficiently close. This threshold may be a predetermined value or range representing an acceptable level of similarity between the provided biometric data and the authoritative data. The threshold may be set based on various factors, including the type of biometric data being compared, the level of security required for the specific application or service, industry standards and best practices, and regulatory requirements. In some implementations, the system may utilize multiple thresholds for different levels of confidence, such as a high threshold for high-security applications requiring a very close match, a medium threshold for general identity verification purposes, and a lower threshold that may trigger additional verification steps rather than outright rejection. The match score generated in step 255 is compared against the predetermined threshold(s) in decision step 260, with the system considering the identity verification successful if the match score meets or exceeds the threshold, or rejecting the verification attempt or requiring additional authentication steps if the score falls below the threshold. In some cases, the system may employ adaptive thresholds that adjust based on factors such as historical performance data, user-specific patterns, environmental conditions, and device characteristics. Machine learning algorithms may be used to continuously refine and optimize these thresholds over time, improving the system's accuracy and reliability. It's important to note that the specific implementation of thresholds and decision-making processes may vary depending on the requirements of the digital credential issuing entity and the particular use case of the identity verification system.

If the match score does not meet the threshold, the method 200 proceeds to an access failure step 265. If the match score meets or exceeds the threshold, the method 200 proceeds to a trust claim pass step 270. Finally, the method 200 concludes with a User digital ID provision step 275, where the application services environment provisions a digital identification credential to the user device.

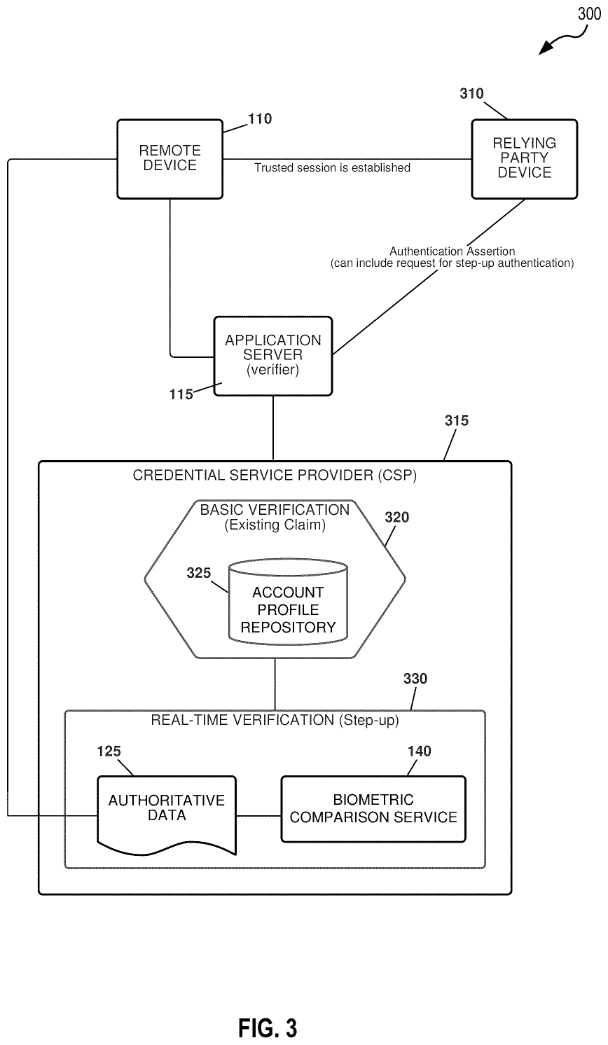

An individual in possession of a digital identification credential created using the method of this invention can then show a visual representation of the digital identification credential to a relying party that wants to authenticate the identity of the individual. Alternatively, an individual in possession of a digital identification credential can choose to share authoritative identifying information about the individual using the authentication and verification system shown in FIG. 3.

Referring now to FIG. 3, a relying party can authenticate an individual's identity and receive authoritative personal information about that individual by communicating either directly or indirectly with the application server 115. In the preferred implementation, the relying party communicates with the application server 115 through a relying party device 310. The relying party device 310 is a device including a processor and memory that stores executable instructions that, when executed by the processor, facilitate performance of operations. The relying party device 310 could be a phone, tablet, computer, server, or other device, including software, which could be a software application, app, website, or other interface. Either the remote device 110 or the relying party device 310 may be used to initiate an identity authentication request.

An individual can initiate an identity authentication request from the remote device 110. The individual logs into the account on the remote device 110. The individual identifies the relying party with which it wishes to share authoritative personal information by entering information into the remote device 110 such as a visual or alphanumeric code, or other identifier. The individual identifies the specific information that the individual consents to share with the relying party by tapping the screen or using any other input method provided by the remote device 110. The individual authorizes the request by tapping the screen or using any other input method provided by the remote device 110. The authorized request is transmitted from the remote device 110 to the application server 115, and the application server 115 transmits the authorized request to the relying party device 310. After receiving the authorized request from the application server 115, the relying party device 310 can respond in several different ways, such as denying the request, accepting the request and receiving authoritative personal information about the individual, or request that additional real-time verification of the individual be performed. If the relying party device 310 declines the request, the process concludes. If the relying party device 310 accepts the request, the application server 115 transmits to the relying party device 310 the specific authoritative personal information authorized by the individual for sharing with the relying party. If the relying party device 310 requests that additional real-time verification of the individual be performed, the application server 115 may utilize the identity verification services 330 to initiate a real-time verification process. Following successful completion of the real-time verification process, the application server 115 transmits an authentication result to the relying party device 310.

A relying party can initiate an identity authentication request from the relying party device 310. The relying party inputs into a relying party device 310 one or more pieces of personal identifying information from an individual using an input method available through the use of the remote device 110, such as a camera, keyboard, or voice interaction. The relying party device 310 transmits a request to the application server 115 including the personal identifying information from the individual, a request for authentication of the individual's identity, optionally a request for certain authoritative personal information about the individual, and optionally a request for real-time verification of the individual. The application server 115 receives the request and may utilize services within the credential service provider environment 315 to attest or deny the authentication request. The application server 115 performs a search 320 to determine whether the personal identifying information received from the relying party device 310 matches authoritative personal information stored directly or indirectly by the application server 115 such as in the account profile repository 325. If the application server 115 identifies a match, the application server 115 transmits a request to the remote device 110 of the individual whose data was matched, requesting that the individual authorize the application server 115 to share specific authoritative personal information with the relying party. The individual authorizes the request by tapping the screen or using any other input method provided by the remote device 110. The individual identifies the specific information that the individual consents to share with the relying party by tapping the screen or using any other input method provided by the remote device 110. The authorized request is transmitted from the remote device 110 to the application server 115, and the application server 115 communicates the authorization to the relying party device 310. If the relying party device 310 does not request real-time verification of the individual, the application server 115 transmits to the relying party device 310 the specific authoritative personal information authorized by the individual for sharing with the relying party. If the relying party device 310 requests that additional real-time verification of the individual be performed, the application server 115 may utilize the identity verification services 330 to initiate a real-time verification process. Following successful completion of the additional real-time verification, the application server 115 transmits an authentication result to the relying party device 310.

For the real-time verification process 330, the application server 115 transmits one or more pieces of personal identifying information or biometric identifying information from the individual's account profile repository 325 to an authoritative data repository 125. The authoritative data repository 125 compares 220 the personal identifying information or biometric identifying information received from the application server 115 to data records in the authoritative data repository 125. If the authoritative data repository 125 identifies a match 225 between the data received from the application server 115 and a data record in the authoritative data repository 125, the authoritative data repository 125 transmits 235 to the application server 115 a response indicating that a match was found, and may also transmit 225 to the application server 115 authoritative identifying information from the matching data record, which may include authoritative biometric information such as an authoritative photograph, fingerprint, or retinal scan. If the authoritative data source does not find a match, the process is failed and the relying party is notified. 230 If the authoritative data source found a match, the remote device 110 requests that the individual use one or more input devices available through the use of the remote device 110, such as a camera or fingerprint reader, in a manner that allows the remote device 110 to create a self-portrait of the individual or obtain other biometric identifying information of the individual, such as a fingerprint or a retinal scan. The remote device 110 collects 240 and transmits biometric identifying information collected from the individual to the application server 115. The application server 115 may cache 245 the information in temporary storage. The remote device 110 may also transmit to the application server 115 information related to the remote device 110, which may include the brand, model, device identifier, operating system, and other information about the remote device 110. The remote device 110 may also transmit to the application server 115 information related to the environment of the remote device 110, which may include the time, date, IP address, physical location, and other information about the environment in which the remote device 110 is being used. The application server 115 transmits 250 the authoritative biometric information and the biometric identifying data to a biometric comparison service 140. The biometric comparison service 140 may be connected either directly or indirectly to the application server 115 and may be a service on a different server or computing device. The biometric comparison service 140 analyzes and compares the biometric identifying data and the authoritative biometric information to determine whether the two data elements were obtained from the same individual, and calculates a match score from that analysis. One skilled in the art understands that the criteria for determining whether the match score is sufficiently high to authorize the issuance of a digital identification credential can be customized by the digital credential issuing entity. The biometric comparison service 140 transmits 255 the match score to the application server 115. The application server analyzes 260 the match score. If the results of applying the criteria to the match score indicates that the authoritative biometric information and the biometric identifying information identify the same individual 265, the application server transmits a message to the remote device indicating that the individual must try again or contact customer support. If the results of applying the criteria to the match score indicates that the authoritative biometric information and the biometric identifying information identify the same individual 270, the application server 115 transmits authoritative identifying information and a message indicating that a valid authenticated digital identification credential has been issued to the remote device 110 and provisions 275 a digital identification credential to the remote device 110.

Referring to FIG. 3, the authentication logic diagram 300 illustrates the interactions between various components of the system for secure identity verification. The diagram depicts a remote device 110, a relying party device 310, an application server 115, and a credential service provider 315. These components work together to authenticate and verify user identities, providing a secure means for digital interactions.

The remote device 110 may be a user's mobile device or computer, equipped with an application that facilitates user interaction with the system. The remote device 110 is capable of obtaining personal identifying information and biometric identifying information from the user, and transmitting this information to the application server 115.

The application server 115 serves as a central hub for processing and verifying the received information. It communicates with the remote device 110 and the credential service provider 315, transmitting personal identifying information and biometric identifying information for verification.

The credential service provider 315 is a key component of the system, encompassing several sub-components that handle different aspects of the verification process. It includes a basic verification provider 320, which handles existing claims, and an account profile repository 325, which stores user account information. The credential service provider 315 also incorporates a real-time verification process 330, which involves two key components: the authoritative data repository 125 and the biometric comparison service 140.

The authoritative data repository 125 is a trusted source of official records or data used for identity verification. It may be maintained by a government entity or another authoritative body. The biometric comparison service 140 performs comparisons of biometric data, enhancing the security and accuracy of the identity verification process.

The relying party device 310 represents any entity that needs to accurately determine an individual's identity in a legally conformant manner. This could be a state government entity, a business, or any other entity that relies on the digital identification credentials provisioned by the system.

In operation, the remote device 110 and the relying party device 310 establish a trusted session with the application server 115. The application server 115, acting as a verifier, receives an authentication assertion from the relying party device 310, which may include a request for step-up authentication. The application server 115 then communicates with the credential service provider 315 to verify the individual's identity and issue a digital identification credential.

In some aspects, the system may also include a mechanism for the relying party to request additional real-time verification of the individual. This could involve obtaining current biometric identifying information from the individual using the remote device 110, transmitting this information to the application server 115, and initiating a real-time verification process with the credential service provider 315.

This authentication logic diagram 300 provides a high-level overview of the system's operation, illustrating the interactions between various components for secure identity verification.

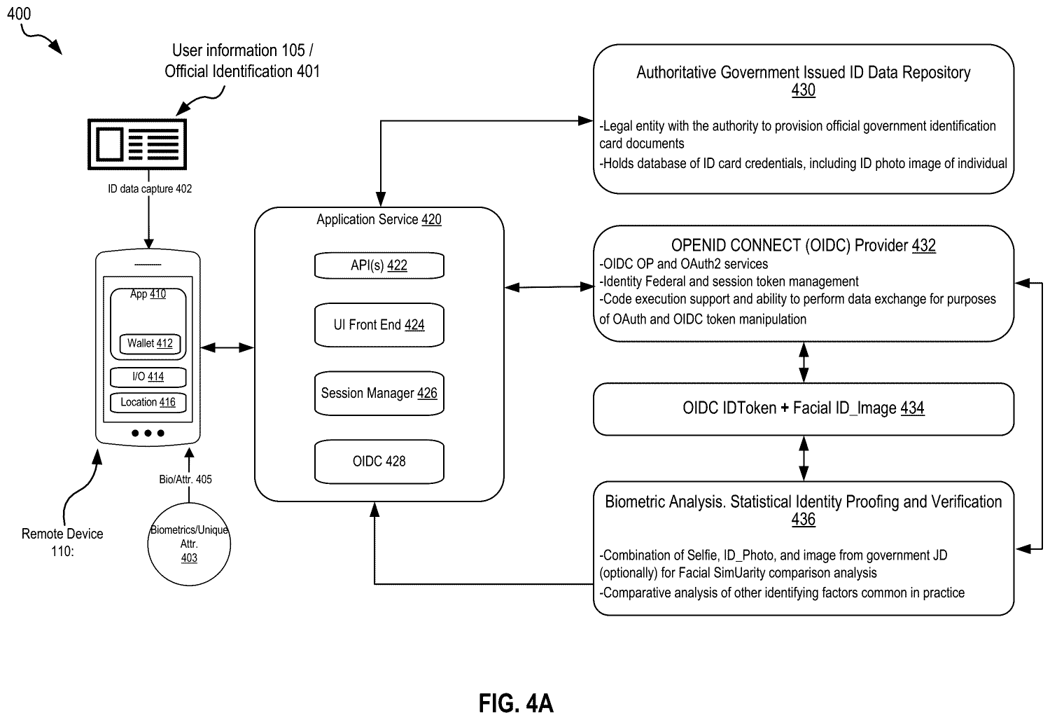

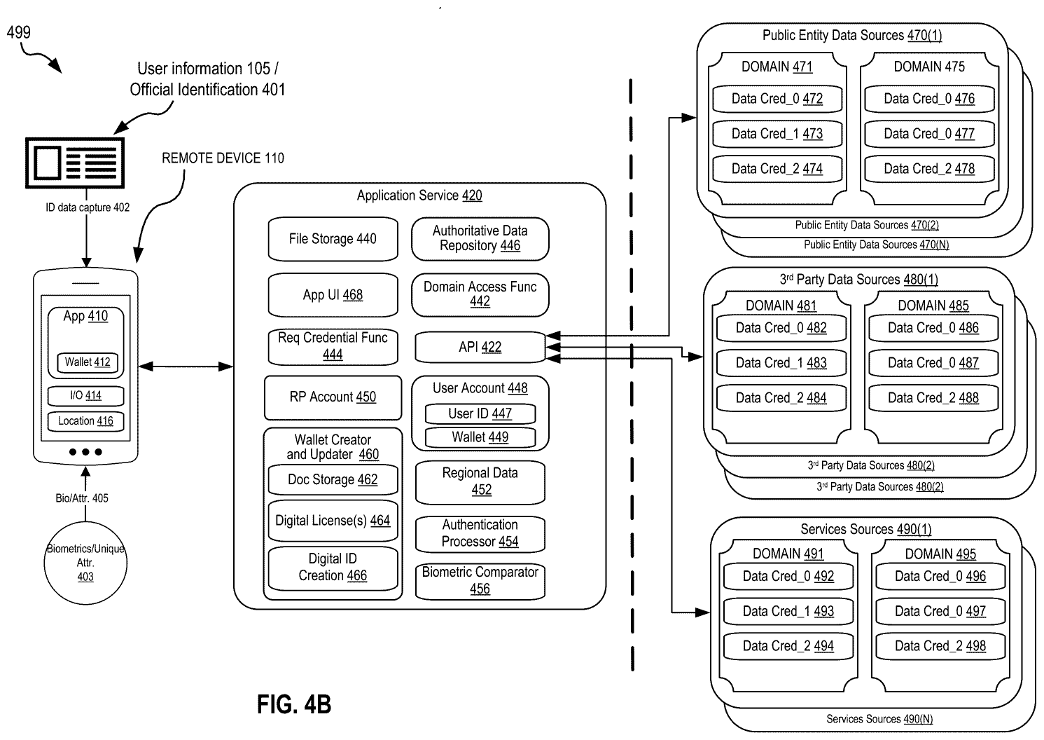

FIG. 4A shows a logical diagram 400, which illustrates the interactions between various components of the system for secure identity verification. The system includes remote device 110, an application service 420, an authoritative government issued ID data repository 430, an OIDC provider 432, an OIDC IDToken and Facial ID_Image component 434, and a biometric analysis, statistical identity proofing and verification component 436.

The remote device 110, which may be a mobile device or a computer, is configured to obtain personal identifying information and biometric identifying information from an individual. This information is then transmitted to the application service 420. The remote device 110 includes an application 410 with components such as an electronic wallet 412, I/O device 414, and location device 416. The electronic wallet 412 may be a digital wallet that stores the individual's digital identification credential and other relevant information as generated and updated by the present systems and methods. The I/O device 414 may be a user interface that allows the individual to interact with the application 410 and input their personal identifying information and biometric identifying information for use by application service 420, for example by ID data capture 402, as described previously and below. The location device 416 may be a GPS or other location-determining component that provides location data of remote device 110, data which may be utilized by app 410 and application service 420.

The remote device 110 may be equipped with various sensors and input mechanisms, e.g., I/O 414, to capture biometric and unique attributes 403 of the user. These attributes may be processed and stored as biometric/attribute data 405. For example, the remote device 110 may use its camera to capture facial images or iris scans, a fingerprint scanner to obtain fingerprint data, or a microphone to record voice patterns. In some cases, the device may also capture behavioral biometrics such as typing patterns or gait analysis through its touchscreen or accelerometer. This biometric/attribute data 405 may then be utilized by the application 410 on the remote device 110 for initial processing or encryption before being transmitted to the application services 420. The application services 420 may further process this data, comparing it with stored templates or using it for identity verification purposes. By capturing and utilizing these biometric and unique attributes, the system may enhance the security and accuracy of the identity verification process, potentially reducing the risk of fraudulent access attempts.

The application service 420 is a server or a network of servers configured to receive and process the personal identifying information and biometric identifying information. It communicates with the remote device 110 and other components of the system to facilitate the identity verification process. The application service 420 includes several components such as an API 422 (also called herein an API service 422), a UI front end 424, a session manager 426, and an OIDC function 428. UI front end 424 may facilitate communications with remote device, such as remote device 110, and companion applications on a remote device, such as app 420. The session manager 426 may manage user sessions and handle user authentication processes. The OIDC function 428 may provide identity federation and session token management services and may cooperate and coordinate with OIDC IDToken and Facial ID_Image component 434.

The authoritative government issued ID data repository 430 is a trusted source of official records or data used for identity verification. It may be maintained by a government entity or another authoritative body. The application service 420 retrieves authoritative personal information from the authoritative government issued ID data repository 430 and send the authoritative personal information and the personal identifying information to the biometric analysis, statistical identity proofing and verification component 436 for comparison. Alternatively, application service 420 sends the personal identifying information to the biometric analysis, statistical identity proofing and verification component 436 and requests the authoritative government issued ID data repository 430 send the authoritative personal information to the biometric analysis, statistical identity proofing and verification component 436 for comparison. Application service 420 then receives a response indicating whether the personal identifying information matches authoritative personal information.

The OIDC provider 432 is a component that provides identity federation and session token management services. It interacts with the application service 420 and the OIDC IDToken+Facial ID_Image component 434. The OIDC IDToken+Facial ID_Image component 434 is an extension of the OIDC IDToken payload that includes the authoritative facial image known only to the government entity which obtained its legal use by the provisions of its ID services.

The biometric analysis, statistical identity proofing and verification component 436 is a service that performs comparisons of biometric data. In one example, it receives the biometric identifying information and the authoritative biometric information from the application service 420, analyzes and compares the biometric data, and generates a match score. The match score quantifies the degree of similarity between the biometric identifying information and the authoritative biometric information.

In some aspects, the system may also include a mechanism for the user to consent to the use of their personal identifying information and biometric identifying information for the purpose of identity verification. This consent-based approach enhances the privacy and security of the system by ensuring that the user's information is used only for the intended purpose and with the user's explicit consent.

Referring to FIG. 4B, the logical diagram 499 illustrates the interactions between various components of the system for secure identity verification. The system comprises remote device 110, application service 420, and multiple external data sources, including public entity data sources 470(1) through 470(N), third party data sources 480(1) through 480(N), and services sources 490(1) through 490(N). Each of these data sources contains multiple domains with associated data credentials, as shown.

The remote device 110, which may be a mobile device or a computer, is configured to obtain personal identifying information and biometric identifying information from an individual. This information is then transmitted to the application service 420. The remote device 110 includes application 410 with components such as electronic wallet 412, I/O device 414, and location device 416. The electronic wallet 412 may be a digital wallet that stores the individual's digital identification credential and other relevant information.

The application service 420 also includes a file storage 440, which may be used to store temporary data during the verification process or more long-term storage, as needed. The file storage 440 may be a database or other storage medium that can store large amounts of data in a structured manner. The application service 420 may use the file storage 440 to store the personal identifying information and biometric identifying information received from the remote device 110, as well as any other data relevant to the identity verification process, user data, replying party data, API translated and normalized data, etc.

The application service 420 further includes a domain access function 442 and a request credential function 444. The domain access function 442 may be responsible for managing access to the various domains within the disparate data sources. The request credential function 444 may handle requests for digital identification credentials from the individual and/or the domains within the disparate data sources.

The application service 420 includes an authoritative data repository 446, which may be used to access and/or store trusted official records or data used for identity verification. The application service 420 utilizes the authoritative data repository 446 to obtain personal identifying information and participate in determining whether the personal identifying information, received from remote device 110, matches authoritative personal information in a data record in the authoritative data repository 446. In another embodiment, authoritative data repository 446 is external to application service 420 and acts as the primary source of authoritative personal information.

The system also includes a user account 448, which may store user account information and manage user authentication processes. The user account 448 may include a user ID 447 and a wallet 449. The user ID 447 may be a unique identifier assigned to the individual, while the wallet 449 may be a digital wallet that stores the individual's digital identification credential and other relevant information.

The system interfaces, via API 422, with multiple external data sources, examples of which are public entity data sources 470(1) through 470(N), third party data sources 480(1) through 480(N), and services sources 490(1) through 490(N). public entity data sources 470(1) through 470(N), third party data sources 480(1) through 480(N), and services sources 490(1) through 490(N).

Public entity data sources 470 may include various government databases at different levels of administration. At the city or county level, examples may include a city's property tax assessment database and a county's voter registration records. At the state level, public entity data sources may include a Department of Motor Vehicles (DMV) database for driver licenses and vehicle registrations, state and/or national identification cards, a state's professional licensing board database for various occupations, and a state's Department of Natural Resources database for hunting and fishing licenses. At the federal level, examples may include the Social Security Administration's database for social security numbers and the Department of State's passport database. These public entity data sources provide authoritative information that can be used for identity verification and credential issuance within the secure identity verification system.

Third party data sources 480(1) through 480(N) may include a variety of non-governmental entities that maintain relevant user information. In the medical field, these sources may include hospital systems, which may store patient records, treatment histories, and diagnostic information. Insurance companies may serve as third party data sources, potentially providing information on health insurance coverage, claims history, or policy details. Commercial sources could include credit reporting agencies, which may offer credit scores and financial history data. Other examples might include pharmacies. which could provide prescription histories, or fitness tracking companies that collect health and activity data. Educational institutions may also serve as third party data sources, potentially offering information on degrees, certifications, or enrollment status. In some cases, employers might act as third party data sources, providing employment verification or professional credentials. In some aspects, services sources may also encompass private sector services such as subscription-based platforms, online retailers with purchase histories, or digital content providers with usage data.

Services sources 490(1) through 490(N) may include a variety of service providers that offer different types of services and maintain relevant user information. Examples from the document include the Supplemental Nutrition Assistance Program (SNAP), license and permit renewal services, Colorado Child Care Assistance Program (CCCAP), Nurse-Family Partnership, Colorado WIC, Medicaid, Behavioral Health Administration Community Services, and Child Health Plan (CHP+). These services may overlap with public data sources in some cases, particularly for government-provided services, for example, the present system and method may interact with one or more service sources services to facilitate renewals of permits or licenses or track professional requirements such as continuing legal education (CLEs) for attorneys. Other potential services sources may include public and/or private transportation systems and services with rider information (e.g., public trains, public buses, and rideshares), and library systems with membership and borrowing records.

Each of these data sources contains multiple domains with associated data credentials. The application service 420, through the API 422, can access and integrate data from these diverse sources, enabling it to provide a comprehensive and accurate verification of an individual's identity. This is achieved by extending the OAuth2 standard to securely deliver a payload of governmental authoritative biometric data, which is then used by an Identity Verification service to perform a biometric analysis. The application service 420, through the API 422, can also access and integrate data from these diverse sources, enabling it to provide current user data for updating user accounts, relying party accounts, to satisfy requests for information, and to provide access to information and services for users.

In some aspects, the system may also include a mechanism for the user to consent to the use of their personal identifying information and biometric identifying information for the purpose of identity verification and selective data access. This consent-based approach enhances the privacy and security of the system by ensuring that the user's information is used only for the intended purpose and with the user's explicit consent.

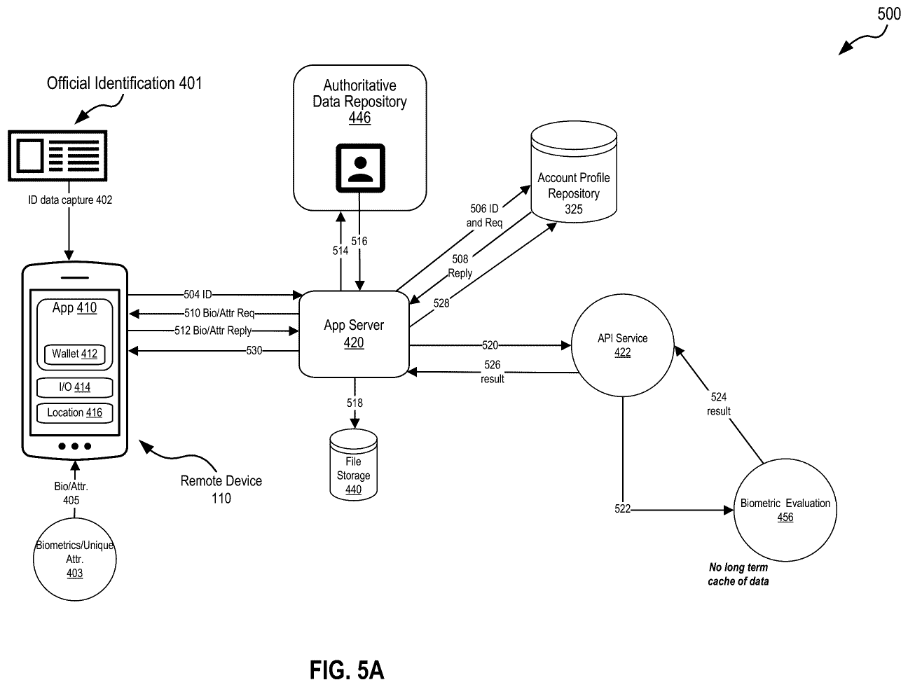

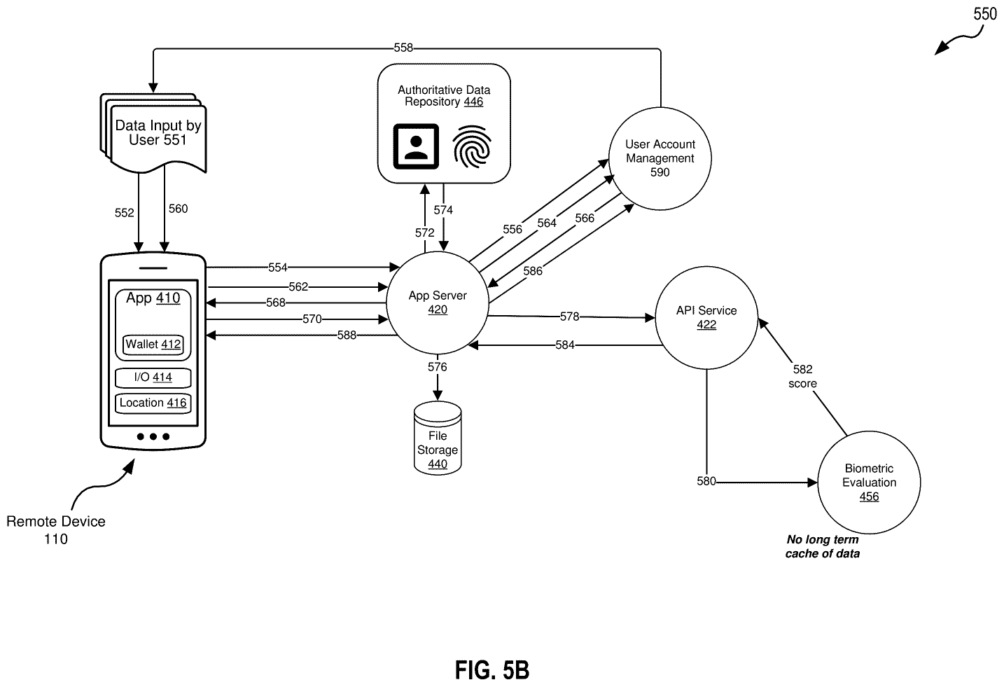

FIG. 5A shows a system diagram 500, which illustrates the interactions between the remote device 110, application service 420, and other components for secure identity verification using authoritative data and biometric evaluation.

The remote device 110 is configured to obtain personal identifying information and biometric identifying information from an individual. This information is then transmitted to the application service 420. The remote device 110 includes application 410 with components such as electronic wallet 412, I/O device 414, and location device 416.

The application service 420 is a server or a network of servers configured to receive and process the personal identifying information and biometric identifying information. It communicates with the remote device 110 and other components of the system to facilitate the identity verification process.

The communication steps 504 through 530 in FIG. 5A illustrate the process of secure identity verification using authoritative data and biometric evaluation. In communication step 504, the remote device 110 initiates the process by transmitting ID data to the application service 420, which may include personal identifying information obtained from the individual. The application service 420 then transmits this ID data along with a request to the account profile repository 325 in communication step 506, initiating the verification process. The account profile repository 325 responds in communication step 508 by sending a reply to the application service 420, which may contain relevant account information.

Communication step 510 involves the application service 420 sending a biometric attribute data request to the remote device 110, possibly requesting additional or specific biometric data. The remote device 110 responds in communication step 512 with a biometric attribute reply, sending the requested biometric data back to the application service 420. In communication step 514, the application service 420 sends an authoritative data request to the authoritative data repository 446, which may be for official records or data used for identity verification. The authoritative data repository 446 then sends an authoritative data reply to the application service 420 in communication step 516, providing the requested official data.

Optional communication step 518 involves the application service 420 sending identity data to file storage 440 for temporary storage, which may include both the user-provided data and the authoritative data. In communication step 520, the application service 420 sends identity data to the API service 422 for further processing. The API service 422 then sends this identity data to the biometric evaluation component 456 for biometric comparison and analysis in communication step 522.

The biometric evaluation component 456 returns a biometric evaluation result to the API service 422 in communication step 524. In communication step 526, the API service 422 forwards this biometric evaluation result to the application service 420. The application service 420 then stores the biometric evaluation result in communication step 528, possibly for future reference or auditing purposes. Finally, in communication step 530, the application service 420 returns a biometric evaluation result (pass/fail) to the remote device 110, indicating whether the identity verification was successful.

These communication steps demonstrate the complex interactions between various components of the system, including the remote device 110, application service 420, account profile repository 325, authoritative data repository 446, file storage 440, API service 422, and biometric evaluation component 456. This process ensures secure and accurate identity verification using both user-provided and authoritative data sources.

In some aspects, the system may also include a mechanism for the user to consent to the use of their personal identifying information and biometric identifying information for the purpose of identity verification. This consent-based approach enhances the privacy and security of the system by ensuring that the user's information is used only for the intended purpose and with the user's explicit consent.

In some embodiments, the API service 422 is used to access authoritative data repository 446 if that is stored in one of the disparate data sources or domains where requests need to be formatted to match the destination and received data needs to be formatted to be useable by application service 420. Additionally, if the biometric evaluation component 456 is within application service 420 then API service 422 is not needed to send and receive data to and from biometric evaluation component 456.

FIG. 5B shows a system 550, which illustrates additional security measures and non-ID data processing components of the system for secure identity verification. The system includes remote device 110, application service 420, a user account management component 590, API service 422, authoritative data repository 446, a data input by user 551, and a biometric evaluation component 456.

The user account management component 590 is responsible for managing user accounts and handling user authentication processes. It interacts with the application service 420 and the remote device 110 to facilitate the identity verification process. The user account management component 590 may store user account information, including personal identifying information and biometric identifying information, and may manage user sessions and handle user authentication processes.

Communication steps 552 through 588 illustrate a detailed process for secure identity verification and data handling within the system. In step 552, user data is entered into remote device 110. In step 554, user data is transmitted from the remote device 110 to the application service 420. This data may include personal identifying information collected from the individual. The application service 420 then sends this data for provisioning of secure handling of digital privacy in step 556, which may involve preparing the data for secure processing and storage.

In steps 558 and 560, the system implements an additional security measure by sending a one-time pass code via a second communications channel and requiring the user to utilize this OTP code to continue the authentication process. The OTP code confirmation is then sent back to application service 420 in step 562. Following successful OTP verification, the application service 420 registers the user with current details in step 564.

Step 566 involves sending data to authenticate the user's session for Identity Verification. This may include transmitting the verified user information to the relevant components of the system for further processing. In step 568, the application service 420 requests access to I/O hardware on the remote device 110 to collect new biometric data. This new biometric data is then captured and transmitted back to the application service 420 in step 570.

The application service 420 then requests prior biometric data from the authoritative data repository (ADR) 446 in step 572, which is received in step 574. Both the new and prior biometric data are stored in temporary storage in optional step 576, ensuring that sensitive data is not retained longer than necessary.

In steps 578 and 580, the new and old biometric data are sent to the API service 422 and then forwarded to the biometric evaluation component 456 for evaluation. The biometric evaluation component 456 performs its analysis and returns a biometric comparison score in step 582. This score is then passed back through the API service 422 to the application service 420 in step 584.

Finally, the biometric score is returned to user account management component 590 in step 586, and to the application 410 on the remote device 110 in step 588. This completes the identity verification process, providing a secure and thorough authentication of the user's identity using both new and authoritative biometric data.

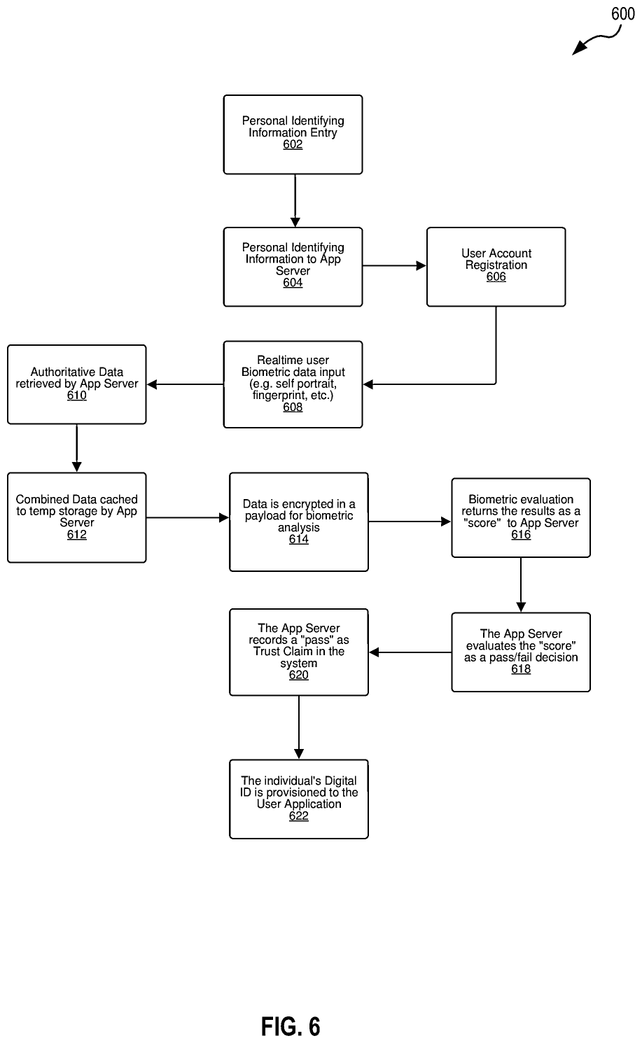

Referring to FIG. 6, the figure illustrates a method 600 for account setup in the system for secure verification of identities. The method 600 begins with a personal identifying information entry step 602, where an individual inputs their personal identifying information into a user device, which may be a mobile device, a computer, or any other device capable of receiving user input. The personal identifying information may include, but is not limited to, the individual's name, address, date of birth, social security number, or any other information that can be used to uniquely identify the individual.

Following the personal identifying information entry step 602, the method 600 proceeds to a step of sending personal identifying information (PII) to the server 604. In this step, the personal identifying information obtained from the individual is transmitted from the user device to an application services environment, represented by the application server 115 in FIG. 1. The application services environment may be a server or a network of servers configured to receive and process the personal identifying information.

Next, method 600 includes a user account registration step 606. During this step, the application services environment creates a user account based on the personal identifying information received from the user device. The user account may be stored in a user account management system, such as user account management 120 in FIG. 1, user account 448 in FIG. 4B, account profile repository 325 in FIG. 5A, user account management component 590 in FIG. 5B and may be used to manage the individual's interactions with the system.

In some cases, the method 600 may also include obtaining biometric identifying information from the individual using the user device. This biometric identifying information may include a facial image, a fingerprint, a retinal scan, or any other biometric data that can be used to uniquely identify the individual. This is represented by the new biometric input step 608 in FIG. 6.

Following the collection of biometric identifying information, method 600 proceeds to an authoritative data retrieval step 610. In this step, the application services environment transmits the personal identifying information to an authoritative data repository, which may be a trusted source of official records or data used for identity verification. The authoritative data repository may be maintained by a government entity, such as a state or federal government entity, or any other entity authorized to hold and manage official identification data.

The method 600 then includes an optional PII data cache step 612, where the application services environment caches the personal identifying information and the biometric identifying information for processing. This may involve storing the data in a temporary storage location, such as temporary data storage 130 in FIG. 1 and file storage 440 in FIGS. 4B, 5A, and 5B, for the duration of the identity verification process.

Next, method 600 includes an optional PII encryption step 614. In this step, the application services environment may encrypt the personal identifying information and the biometric identifying information before transmitting it to other components of the system. This additional layer of security helps to protect the individual's sensitive data during the identity verification process.

Following the optional encryption step 614, method 600 proceeds to a biometric score returned step 616. In this step, the application services environment transmits the biometric identifying information and the authoritative biometric information to a biometric comparison service, which may be a service that performs comparisons of biometric data. The biometric comparison service analyzes and compares the biometric data received from the remote device and the biometric data stored in an authoritative data repository, and generates a match score. The match score quantifies the degree of similarity between the biometric identifying information and the authoritative biometric information.

The method 600 then includes a biometric score evaluation step 618. In this step, the application services environment analyzes the match score to determine whether to issue a digital identification credential to the individual. This decision may be based on whether the match score meets a predetermined threshold, indicating a sufficient degree of similarity between the biometric identifying information and the authoritative biometric information.

If the match score meets or exceeds the predetermined threshold, the method 600 proceeds to a trust claim pass step 620, where a “pass” is recorded as a Trust Claim in the system. If the match score does not meet the predetermined threshold (not shown), the individual is notified of the failed identity verification and may be prompted to try again or contact customer support (not shown).

Finally, method 600 includes a User digital ID provision step 622, where the individual's Digital ID is provisioned to the user application and/or user account, for example, in the user's wallet. This completes the account setup process, providing the individual with a secure and verified digital identification credential that can be used for various purposes.

In some aspects, method 600 may also include additional steps or variations, such as additional security measures, user consent processes, or other features designed to enhance the security, accuracy, and user-friendliness of the system. For example, the system may include a mechanism for the user to consent to the use of their personal identifying information and biometric identifying information for the purpose of identity verification. This consent-based approach enhances the privacy and security of the system by ensuring that the user's information is used only for the intended purpose and with the user's explicit consent.

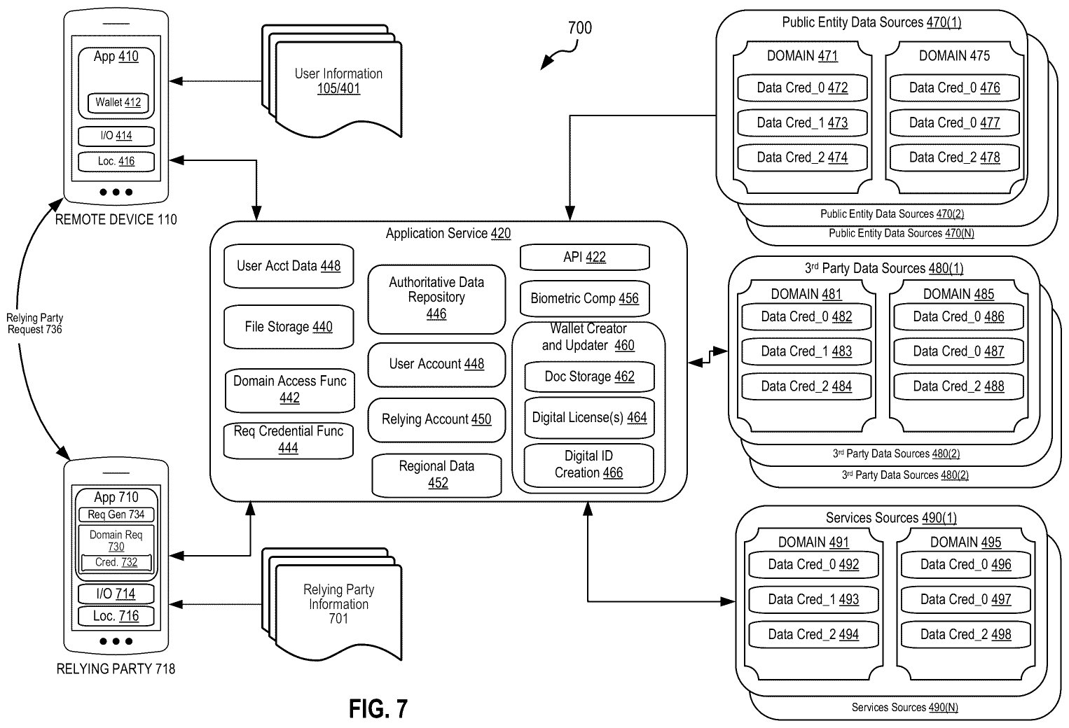

FIG. 7 shows a system 700, which illustrates the interconnections between remote device 110, application service 420, and a unique request generator 734 within a relying party device 718 for user verification and data request. System 700 shows how the system can securely handle user data and authentication requests, highlighting the role of the disparate data sources and the normalization process facilitated by the API 422.

The relying party 718 represents an entity that needs to accurately determine an individual's identity in a legally conformant manner. It includes an application 710 that interfaces with various components. An Input/Output (I/O) 714 component allows the relying party to input and receive information, including relying party information 701 which may contain identification and biometric data. This information is entered through the I/O 714 interface. A location 716 component may provide geographical context for the relying party's operations. The application 710 also incorporates a request generator 734, which may be used to create unique requests for user data or authentication. A domain request 730 component may handle specific data domain access requests, while a credentials 732 component may store or manage the relying party's own authentication credentials. Together, these components enable the relying party 718 to interact securely with the identity verification system, request user data, and participate in the authentication process.

The system 700 also shows request generator 734, which is used by the relying party to generate a unique request 736 between relying party device 718 and remote device 110, for a specific. one-time request to access user data on remote device 110, in a user account in application service 420, and/or at a disparate data source 470-490, and to initiate relying party 718 functions. Examples of unique request 736 include, but are not limited to, an optical communication, a 3GPP side-link communication, a Quick Response (QR) code, an Near-Filed Communication (NFC) message, a Bluetooth (BTE) message, a Uniform Resource Locator (URL), a bar code, an image, and audio file, an Short Message Service (SMS) message, at text message, an Non-Fungible Token (NFT), a link to a web page, etc. Examples of relying party 718 functions include, but are not limited to, age verification for purchasing age-restricted products or services, such as alcohol or tobacco; identity verification for financial transactions, such as opening a bank account or applying for a loan; access control for secure physical locations, such as government buildings or restricted areas in a workplace; background checks for employment purposes, including verification of professional credentials or certifications; and voter authentication for online or in-person voting systems to ensure the integrity of electoral processes. Additionally, police officers may use the system for license and vehicle registration verification during traffic stops or criminal investigations, while park rangers may employ it for validating hunting and fishing licenses or permits for accessing restricted natural areas. The unique request 736 may contain information specific to the relying party and the specific request, such as the type of data requested, the purpose of the request, a badge number of a police officer, and other relevant details. The unique request 736 communicated to the user device 110, for example by scanning a RP device 718 created unique QR code by the user device 110 or by transmitting a unique data portion created by RP device 718 and to user device 110 either directly or indirectly. Indirect communication (not shown) of the unique request 736 may be via application service 420. The information contained in the unique request is processed for authentication and sent to the application service 420 for processing.

System 700 also includes multiple disparate data sources, represented by public entity data sources 470, third party data sources 480, and services sources 490. These data sources provide a wide range of data that can be used for identity verification and provide data unique to the user of remote device 110 and relying party 718. The data from these sources may be in various, non-cooperative formats and may require normalization via the API 422 for functional use by the application service 420, user device 110, and the relying party 718.

In operation, the application service 420 may transmit personal identifying information and biometric identifying information to the disparate data sources and receive a response indicating whether the information matches authoritative personal information in a data record. The system may also involve transmitting biometric identifying information to the biometric evaluation component 456 and receiving a match score. The application service 420 may analyze this match score to determine whether to issue a digital identification credential to the individual, to provide application service 420 access to the user's data, or to provide relying party 718 access to data requested. This multi-layered approach to identity verification combines personal information, authoritative data, and biometric comparisons to ensure secure and accurate authentication.

In some aspects, the system may also include a mechanism for the user to consent to the use of their personal identifying information and biometric identifying information for the purpose of identity verification and data access. This consent-based approach enhances the privacy and security of the system by ensuring that the user's information is used only for the intended purpose and with the user's explicit consent.

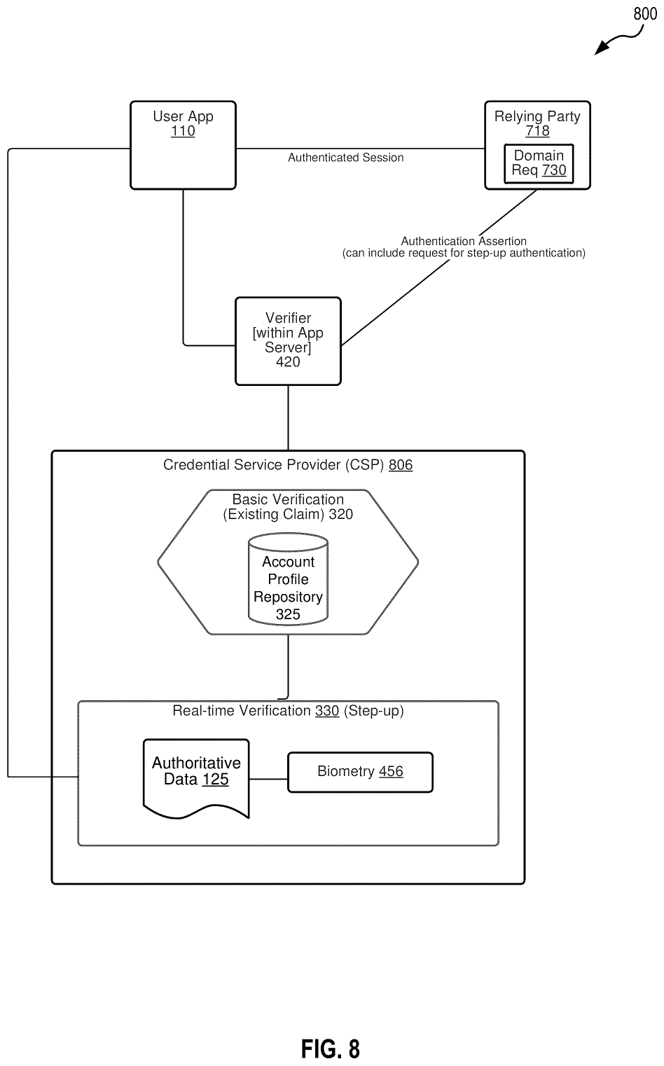

FIG. 8 shows a system 800, which illustrates the interactions between the remote device 110, relying party 718, application service 420, and credential service provider 806 for user verification. System 800 highlights the role of basic and real-time verification processes in the secure use of consent-based authoritative data within biometry-based digital identity authentication and verification.

The system diagram 800 shows relying party 718, which may be an entity that needs to verify the identity of the individual for a specific purpose. The relying party 718 communicates with the application service 420 to request and receive user data. The relying party 718 includes an application 710, which may be a software application, or a web-based platform used to interact with the individual and the application service 420.

The credential service provider 806 is a service that provides identity verification and credential issuance services. Credential service provider 806 is similar or the same as credential service provider 315. It includes a basic verification provider 320 and a real-time verification process 330, which performs real-time identity verification. The real-time verification process 330 includes an authoritative data repository 125, which contains authoritative personal and biometric information, and a biometric comparator 456, which performs biometric comparisons.

In operation, the remote device 110 transmits personal identifying information and biometric identifying information (e.g., based at least in part on user information 105/401) to the application service 420. The application service 420 then communicates with the credential service provider 806 to verify the identity of the individual. The basic verification provider 320 and the real-time verification process 330 work together to compare the received information with authoritative data and generate a match score. If the match score meets a predetermined threshold, a digital identification credential is issued to the individual. The application service 420 then transmits an authentication result to one or both of remote device 110 and relying party 718, indicating the outcome of the identity verification process.

In some aspects, the system may also include a mechanism for the user to consent to the use of their personal identifying information and biometric identifying information for the purpose of identity verification. This consent-based approach enhances the privacy and security of the system by ensuring that the user's information is used only for the intended purpose and with the user's explicit consent.

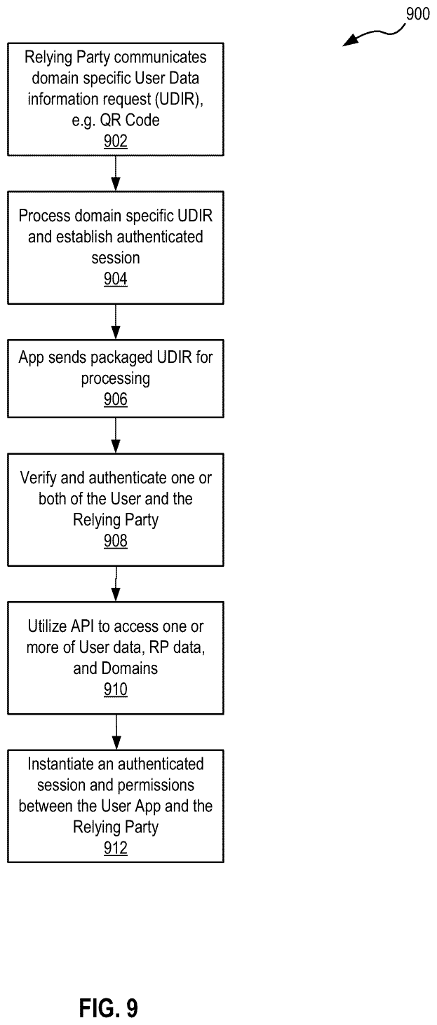

Referring to FIG. 9, the figure illustrates a communication flow 900 for verifying a relying party and domain of access via an application service. Communication flow 900 begins with a relying party communicating a domain-specific User Data information request (UDIR) 902 to the application user interface (App UI) 468. This request may include specific data elements that the relying party needs to verify the user's identity or to perform a specific function.

Upon receiving the UDIR, the App UI 468 processes the request and establishes an authenticated session 904 with the relying party. This authenticated session ensures that the communication between the App UI 468 and the relying party is secure and that the data exchanged is protected from unauthorized access.

Next, the App UI 468 sends a packaged UDIR 906 to the application service 420. The packaged UDIR may include the requested data elements as well as additional information such as the user's identification credentials and session information. The application service 420 then verifies and authenticates one or both of the User and the Relying Party 908. This step ensures that the user and the relying party are who they claim to be and that they are authorized to provide and access the requested data.

Once the user and the relying party are authenticated, the application service 420 utilizes the API 422 to access one or more of User data, RP data, and domains data 910. The API 422 facilitates the retrieval of the requested data from the relevant data sources, which may include public entity data sources, third party data sources, and services sources.

Following the data retrieval, application service 420 instantiates an authenticated session and permissions between the User App and the Relying Party 912. This authenticated session allows the user and the relying party to securely exchange the requested data and to perform the necessary verification processes.

In some cases, the communication flow 900 may also include additional steps or variations. For example, the application service 420 may implement additional security measures such as multi-factor authentication or encryption to further enhance the security of the communication flow. Additionally, application service 420 may utilize artificial intelligence techniques to analyze the requested data and to provide more accurate and efficient verification results.

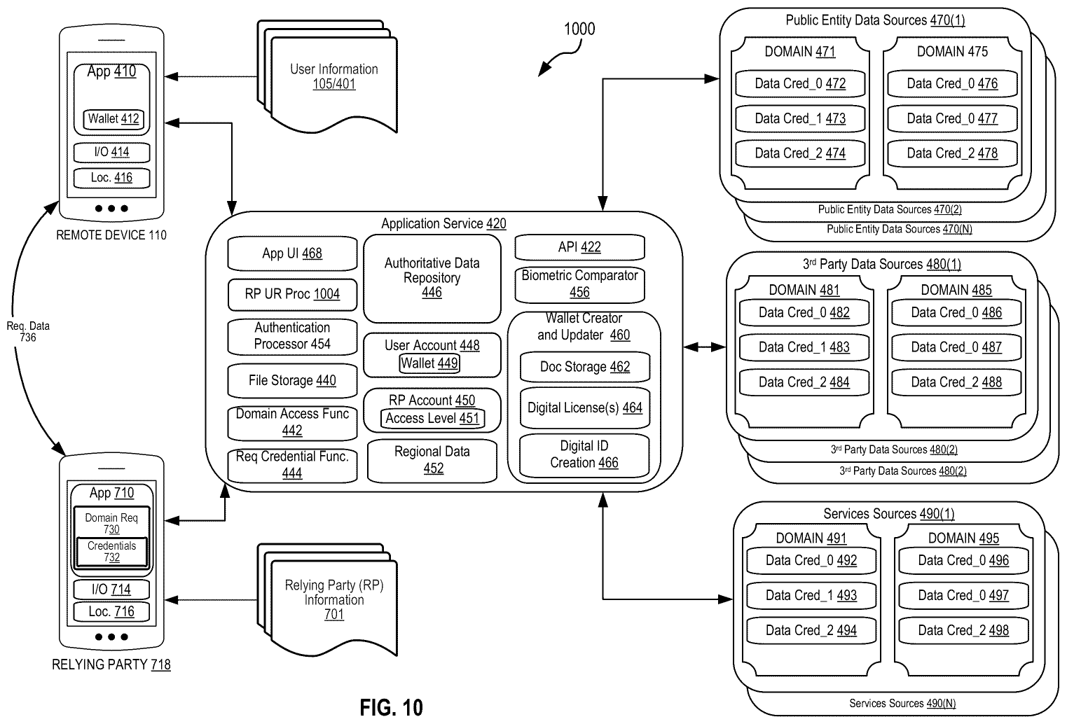

FIG. 10 illustrates a system 1000 for user data and domain data access after verification. The system includes a remote device 110, an application service 420, and multiple data sources 470-490, as similarly described above, facilitating secure access to user and domain data after initial verification.

The remote device 110 includes an application 410 with an electronic wallet 412, I/O device 414, and location device 416. Application 410 interfaces with user information 105/401, allowing users to input and access their personal data. The electronic wallet 412 may store digital identification credentials and other relevant user information, which can be updated in real-time through the system's connections to various data sources.

The application service 420 acts as a central hub for processing and verifying user data. It contains several key components, including an application user interface 468, an authoritative data repository 446, a biometric comparator 456, an authentication processor 454, and a regional data 452. Regional data 452 may cooperate with a location service to provide and or access regional specific data to a user or a relying party, e.g., local taxes, regional specific rules and laws, temporary local restrictions (using both time and location data), etc. These components work together to facilitate secure access to user data and perform real-time identity verification.

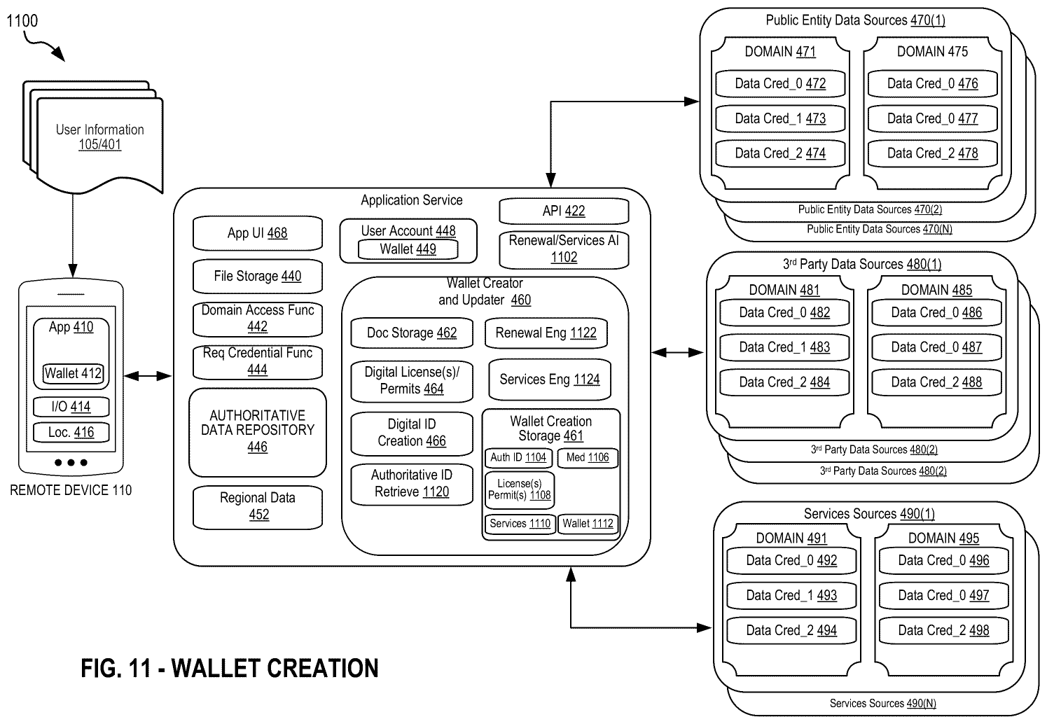

The user account 448 within the application service 420 includes a digital wallet 449, which may be continuously updated with the latest user information, for example by or with coordination with a wallet creator and updater 460. Wallet creator and updater 460 may include a document storage 462 for storing retrieved or created documents used or created in one or both of the wallet creation and updating processes, a digital license(s) 464 for storing electronic versions of licenses (e.g., driver license, universal identification, fishing license(s), hunting license(s), professional licenses/certifications, etc.) and a digital ID creation 466 for generating one or more user or relying party digital credentials. Wallet creator and updater 460 may include additional elements (see for example, FIG. 11). Similarly, a RP account 450 contains an access level 451, which determines the extent of data access granted to the relying party, and may other elements such as a relying party ID, (not shown) and a digital wallet (not shown).

A crucial feature of the system is its ability to access and integrate data from multiple disparate sources. These include public entity data sources 470(1), 470(2), up to 470(N); third party data sources 480(1), 480(2), up to 480(N); and services sources 490(1) up to 490(N). Each data source contains multiple domains, for example, domain 471, domain 475, domain 485, domain 491, etc., with each domain having associated data credentials, for example, e.g., data credential 472-474 for domain 471, data credential 476-478 for domain 475, data credential 485-488 for domain 485, data credential 492-494 for domain 491, etc.). More or fewer domains and data credentials may be present, utilized, added, and or removed without departing from the scope here.

The API 422 plays a vital role in accessing these disparate data sources. It may normalize data from various non-cooperative formats, enabling seamless integration and use by the application service 420, remote device 110, and relying party 718. This allows for real-time access to up-to-date user data and relying party data across different domains.

The system facilitates secure access to user data and domain data after verification through a multi-step process. When a relying party 718 needs to access user data, it may generate a unique request (relying party request 736) using its application 710. This request is processed by application service 420, for example by a RP unique request processor 1004, which verifies at least the user's identity and the relying party's identity and data and domain access rights.

Once verified, the application service 420 can access the relevant data from the appropriate sources using the API 422. This may involve retrieving data from the user account 448, querying the authoritative data repository 446, or accessing external data sources. The retrieved data is then securely transmitted to the relying party 718, ensuring that only authorized, up-to-date information is shared.

The system's ability to access and update user data in real-time across multiple sources ensures that the information in the user's application 410, wallet 412, and user account 448 is always current. This real-time data access and updating capability extends to the RP account 450 as well, ensuring that relying parties always have access to the most recent and accurate user information.

In some aspects, the system may incorporate consent mechanisms, allowing users to control which data is shared with relying parties. This consent-based approach may be managed through application 410 on the remote device 110, enhancing user privacy and data control.

The system 1000 thus provides a comprehensive solution for secure, real-time access to user and domain data, leveraging multiple data sources and advanced verification processes to ensure data accuracy and security.

Referring to FIG. 11, the system diagram 1100 illustrates the process of wallet creation and management in the context of secure identity verification. System 1100 includes a remote device 110, an application service 420, and a renewal/services Artificial Intelligence (AI) 1102. These components interact to create and manage a digital wallet for the user, enabling dynamic updates and services based on data from various sources.

The renewal/services AI 1102 is a unique component of the system 1100. It is designed to analyze the user's data and identify potential services or renewals based on the analysis. The renewal/services AI 1102 may use machine learning algorithms or other AI techniques to analyze the user's data and make predictions or recommendations. This feature enhances the system's ability to provide personalized and relevant services to the user. In some aspects, the renewal/services AI 1102 may identify potential services or renewals based on the analysis of user data. The system may detect when a user's driver license is approaching its expiration date and proactively notify the user, offering a streamlined renewal process through the digital wallet. Based on the user's vehicle ownership data, the AI may identify when a vehicle registration is due for renewal and provide a convenient way to complete the process within the application. The system may analyze the user's passport expiration date and travel history to suggest an appropriate time for passport renewal, potentially offering expedited services if frequent international travel is detected. For users with professional licenses or certifications, the AI may track continuing education requirements and expiration dates, suggesting relevant courses or renewal processes to maintain the user's professional standing. Additionally, the system may analyze changes in the user's personal information, such as age or family status, to recommend appropriate health insurance policy updates or new coverage options that better suit the user's current needs.

A wallet creation storage 461, which may be part of or in communication with document storage 462, also includes several data storage elements, represented by authorized ID 1104, medical data 1106, licenses/permits 1108, services 1110, and wallet 1112. These data sources provide a wide range of data that can be used for identity verification and wallet management. The data from these sources may be in various formats and may require normalization via the API 422 for functional use by the application service 420, remote device 110, and the renewal/services AI 1102.

The wallet creator and updater 460 may incorporate several components to manage and maintain the digital wallet. It may include an authoritative ID retrieve function 1120, which may be used to obtain verified data from authoritative sources for processing by the wallet creator and updater 460 and for storage in authoritative ID 1104. This function may ensure that the wallet contains the most up-to-date and accurate identification information. The wallet creator and updater 460 may also include a renewal engine 1122, which may be responsible for managing the renewal process for various licenses, certifications, and permits. This engine may interact with the licenses and permits component 1108, providing updated data and initiating renewal processes as needed. Additionally, the wallet creator and updater 460 may incorporate a services engine 1124, which may facilitate access to and updating of data in the services component 1110. This engine may enable the wallet to interact with various governmental and private services, potentially allowing for real-time updates and seamless integration with external service providers via the various data sources 470-490 and their respective domains.

In some aspects, the system may also include a mechanism for the user to consent to the use of their personal identifying information and biometric identifying information for the purpose of identity verification and data access. This consent-based approach enhances the privacy and security of the system by ensuring that the user's information is used only for the intended purpose and with the user's explicit consent.

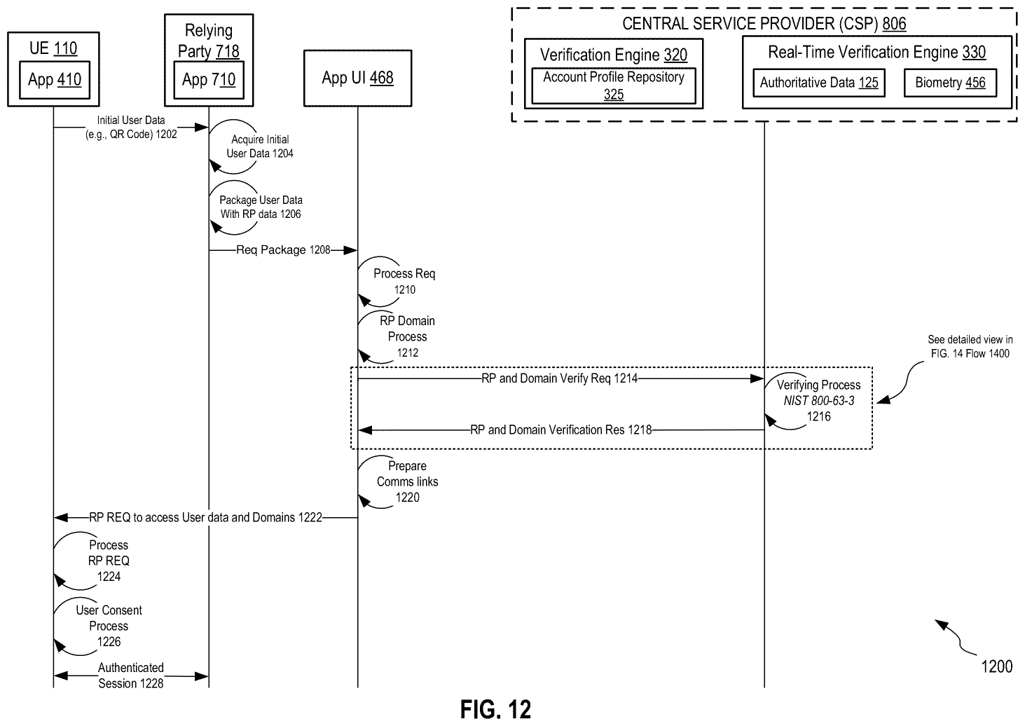

Referring to FIG. 12, a detailed communication flow 1200 is illustrated for verifying a relying party and domain access. The process involves interactions between a remote device 110, an application user interface 468, a credential service provider (CSP) 806, and a relying party 718. The communication flow 1200 includes several steps, each utilizing specific components of the system.

The process begins with an initial user data acquisition step 1202, where the remote device 110 acquires user data. This data may include personal identifying information, biometric data, or other relevant user information. Following this, a user data capture step 1204 occurs, in which the application 710 on the relying party 718 captures the user data. This step may employ various input methods such as text entry, camera for biometric capture, QR code, or accessing stored information in the device.

Next, a user data packaging step 1206 is performed, where application 710 packages the captured user data, preparing it for transmission. This may involve encryption or formatting the data according to specific protocols and/or adding relying party data and/or instructions. The packaged user data is then transmitted from the relying party device 718 to the application user interface 468 in a request package transmission step 1208. This transmission may occur over a secure network connection to protect the user's sensitive information.

Upon receiving the data, the application user interface 468 processes it in a data request details step 1210, extracting the details of the request. This may involve parsing the data package and identifying the specific domains or information being requested. The application user interface 468 then performs a domain processing step 1212, addressing the domain-specific aspects of the request. This may include determining which data sources need to be accessed and what permissions are required.

A verification request step 1214 follows, where the application user interface 468 sends a verification request to the credential service provider 806. This request includes the necessary information to authenticate the user and verify the relying party's access rights. The credential service provider 806, specifically the real-time verification engine 330, then performs a verification process 1216. This may involve checking the user's credentials against the authoritative data 125 and using the biometric comparator 456 to verify biometric information.

After the verification process, a domain verification response step 1218 occurs, where the credential service provider 806 sends a response back to the application user interface 468, indicating the results of the verification process. This response may include information about which domains the relying party is authorized to access. Based on these results, the application user interface 468 prepares the necessary communication links in a communications link preparation step 1220. This may involve setting up secure channels for data transmission between the user and the relying party.

The relying party 718 then sends an access request 1222 to the remote device 110, specifying the particular data or domains it wishes to access. In response, the remote device 110 initiates a process initiation step 1224 to handle the relying party's access request. This may involve preparing the requested data or setting up the necessary permissions.

A user consent process step 1226 may then be engaged by remote device 110, allowing the user to review and approve the data being shared with the relying party. This step ensures user privacy and control over their personal information. Finally, an authenticated session step 1228 establishes a secure session between the remote device 110 and the relying party 718, allowing for the exchange of authorized data between the user and the relying party.

### Examples of Relying Party Access to Domains

Police officer accessing DMV data: A police officer, as a relying party, may have authorized access to certain public entity data sources and domains, such as within the Department of Motor Vehicles (DMV) database. For instance, during a traffic stop, the officer may access the driver license information, vehicle registration details, and driving record. However, the officer's access may be limited to only the necessary information for law enforcement purposes and may not include sensitive personal data unrelated to driving or vehicle ownership.

Healthcare provider accessing medical records: A healthcare provider, as a relying party, may have access to 3^{rd} party data sources and domains, such as a patient's medical records within a health information exchange domain. This access would typically be limited to relevant medical history, current medications, allergies, and recent test results. The healthcare provider would not have access to the patient's financial information or other non-medical personal data stored in different domains.

Financial institution accessing credit information: A bank, as a relying party, may have access to 3^{rd} party data sources and domains, such as a user's credit score and credit history domain when processing a loan application. However, the bank's access would be restricted to financial-related information and would not extend to other domains such as medical records or educational history.

Government agency accessing tax information: A tax authority, as a relying party, may have access to public entity data sources and domains, such as an individual's tax-related domain, including income information, tax returns, and employment history. However, their access would be limited to this specific domain and would not include unrelated personal information from other domains.

In all these cases, the system ensures that relying parties only have access to the specific domains and data necessary for their authorized functions, while restricting access to other sensitive user information. The user consent process adds an additional layer of privacy protection, allowing users to control the sharing of their personal data across different domains.

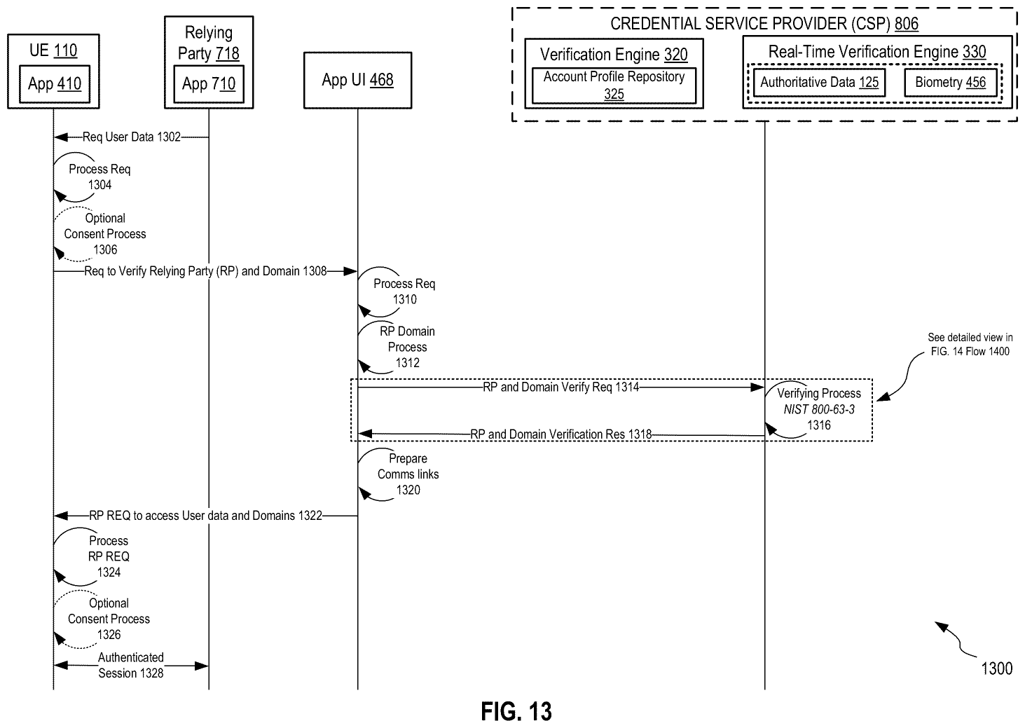

FIG. 13 shows a communication flow 1300, which illustrates a process of verifying a relying party 718 and their domain(s) of access via the application service.

The process involves interactions between the UE 110, application user interface (App UI) 468, credential service provider (CSP) 806, and relying party 718. Communication flow 1300 includes several steps, each involving specific components of the system. The Application Service is shown as App UI 468 and CSP 806 to simplify the figures and to ease explanation, but it will be understood that all functionality, elements, components, processing, storage, etc. as described previously and below may be included.

The process begins with an initial user data acquisition step 1302, where the UE 110 acquires, via App 410, a unique request from the relying party 718, which is uniquely generated by App 710. Examples of the unique request may come in the form of a QR code, a BLE message, a NFC message, etc. The formation of the unique request may be generated based on replying party 718 data and the user data requested. This data may include a request for personal identifying information, instructions, biometric data, user history related to the relying party domain(s) (e.g., driving history, medication refills, etc.), or other relevant user information. Following this, a unique message processing step 1304 occurs, in which the application 410 on the UE 110 processes the unique request. This step may employ various input methods such as text entry, camera for biometric capture, or accessing stored information in the device. At this point (or at a later point) the user may have an option to provide consent to the request in whole or in part in step 1306.

Next, application 410 packages some user data, combining it with the unique request, and preparing it for transmission. The packaged data is then transmitted from UE 110 to the App UI 468 in a request package transmission step 1308. This transmission may occur over a secure network connection to protect the user's sensitive information.

Upon receiving the data, the App UI 468 processes it in step 1310, extracting the details of the request, the user information, and optionally the user selected consent data. This may involve parsing the data package and identifying the specific domains or information being requested. The App UI 468 then performs a domain processing step 1312, addressing the domain-specific aspects of the request. This may include one or more of determining which data sources need to be accessed, what permissions a replying party may have and are required to access the domains, and what the user has consented to.

A verification request step 1314 follows, where the App UI 468 sends a verification request to the CSP 806. This request includes the necessary information to authenticate the relying party and to verify the relying party's domain access rights and privileges. The CSP 806, specifically the real-time verification engine 330, then performs a verification process 1316. This may involve checking the user's credentials against the authoritative data 125 and using the biometric comparator 456 to verify biometric information. Verification may be performed as per the NIST 800-63-3 standard, as one non-limiting example.

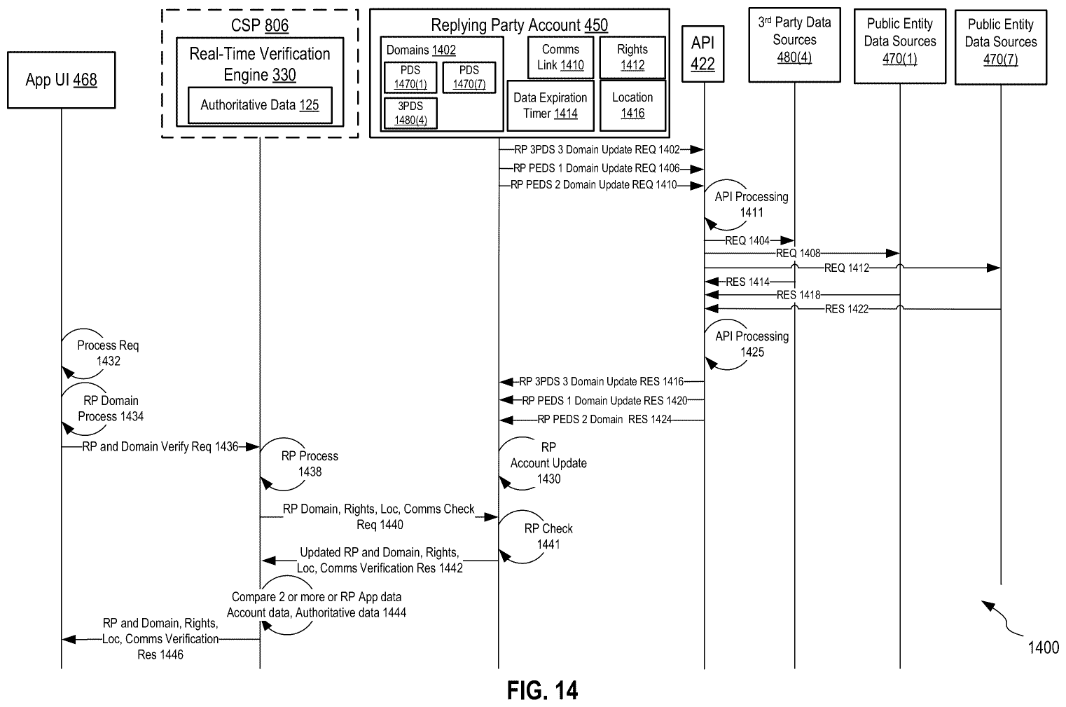

After the verification process, a domain verification response step 1318 occurs, where the CSP 806 sends a response back to the App UI 468, indicating the results of the verification process. This response may include information about which domains the relying party is authorized to access. One example of the verification process is shown in detail in FIG. 14 by communication flow 1400. Other verification processes may be utilized without departing from the scope herein.

Based on these results, the App UI 468 prepares the necessary communication links in a communications link preparation step 1320. This may involve setting up secure channels for data transmission between the user and the relying party.

The relying party 718 and or app 710 then sends an access request 1322 to UE 110, specifying the particular data or domains it wishes to access. In response, UE 110 initiates a process initiation step 1324 to handle the relying party's access request. This may involve preparing the requested data or setting up the necessary permissions.

Optional user consent process step 1326 may then be engaged by UE 110, allowing the user to review and approve the data being shared with the relying party. This step ensures user privacy and control over their personal information. Finally, an authenticated session step 1328 establishes a secure session between the UE 110 and the relying party 718, allowing for the exchange of authorized data between the user and the relying party.

In some aspects, the system may also include a mechanism for the user to consent to the use of their personal identifying information and biometric identifying information for the purpose of identity verification. This consent-based approach enhances the privacy and security of the system by ensuring that the user's information is used only for the intended purpose and with the user's explicit consent.

Referring to FIG. 14, a detailed view 1400 of the relying party domain of access process is illustrated. This process involves interactions between the application user interface 468, the credential service provider 806, the relying party account 450, API 422, and disparate data sources 470(1), 470(7), and 480(4). The process includes several steps, each involving specific components of the system.

The process begins with a 3^{rd} party data source domain update request 1402. The relying party account 450 in application service 420 (not shown) sends a request to API 422, which processes the request in step 1411 to convert the request to a format usable by 3PDS 480(4). In step 1404, API 422 sends the 3PDS 480(4) formatted request to 3PDS 480(4) to request an update the domain specific data for relying party account 450.

Next, a request is sent to API 422 to request to update the relying party's account data with current public entity data source (PEDS) 470(1) domain data in request 1406. API 422 processes the request in step 1411 to convert the request to a format usable by PEDS 470(1). In step 1408, API 422 sends the PEDS 470(1) formatted request to PEDS 470(1) to request an update the domain specific data for relying party account 450.

Next, a request is sent to API 422 to request to update the relying party's account data with current PEDS 470(7) domain data in request 1410. API 422 processes the request in step 1411 to convert the request to a format usable by PEDS 470(7). In step 1412, API 422 sends the PEDS 470(7) formatted request to PEDS 470(7) to request an update the domain specific data for relying party account 450.

A response is then sent from 3PDS 480(4) to API 422 to update the relying party's account 450 data with current 3PDS 480(4) domain data in response 1414. API 422 processes the response in step 1425 to convert the response to a format usable by application service 420 (not show). In step 1416, API 422 sends the formatted response to relying party account 450 to update, in step 1430, the domain specific data in 3PDS 1480(4) in domains 1402.

A response is then sent from PEDS 410(1) to API 422 to update the relying party's account 450 data with current PEDS 410(1) domain data in response 1418. API 422 processes the response in step 1425 to convert the response to a format usable by application service 420 (not show). In step 1420, API 422 sends the formatted response to relying party account 450 to update, in step 1430, the domain specific data in PEDS 1470(1) in domains 1402.

A response is then sent from PEDS 410(7) to API 422 to update the relying party's account 450 data with current PEDS 410(7) domain data in response 1422. API 422 processes the response in step 1425 to convert the response to a format usable by application service 420 (not show). In step 1424, API 422 sends the formatted response to relying party account 450 to update, in step 1430, the domain specific data in 3PDS 1470(7) in domains 1402.

It will be understood that the above domain updates may be performed prior to the below steps, including minutes, hours or days prior, or may be shifted to be incorporated into the below steps to create a real-time update process. Further, the above steps may be performed in any order and are not limited to the order described above. Also, some steps may be performed together for bulk processing or bulk communication.

In step 1432, the application user interface 468 is shown processing a received request, which is similar or the same as process steps 1210 and 1310 in FIGS. 12 and 13, respectively. In step 1434, the application user interface 468 is shown performing a relying party domain processing step, which is similar or the same as process steps 1212 and 1312 in FIGS. 12 and 13, respectively. In step 1436, the application user interface 468 sends a relying party domain verification request to real-time verification engine 330, which is similar or the same as process request steps 1214 and 1314 in FIGS. 12 and 13, respectively.

In step 1438 CSP 806 processes the received relying party domain verification request, and steps 1440, 1441 checks the relying party account for one or more of domains, rights, location, and comms. A result is sent back to CSP 806 in step 1442, which compares the requested domain access with the accessible relying party domains in step 1444. The result is then sent back to the App UI 468 in step 1446, which is similar to steps 1218 and 1318 in FIGS. 12, and 13, respectively.

In some aspects, the process may also involve user consent for sharing specific data elements. For instance, before sending a domain update request, the application user interface 468 may prompt the user for consent to share certain data elements with the relying party. This consent-based approach enhances the privacy and security of the system by ensuring that the user's information is used only for the intended purpose and with the user's explicit consent.

It will be understood that one or more additional application service 420 elements may replace or cooperate in the above described communication and processing steps and that the simplified figures and above description is meant to ease explanation and not meant to be limiting or restrict the systems and methods in any way.

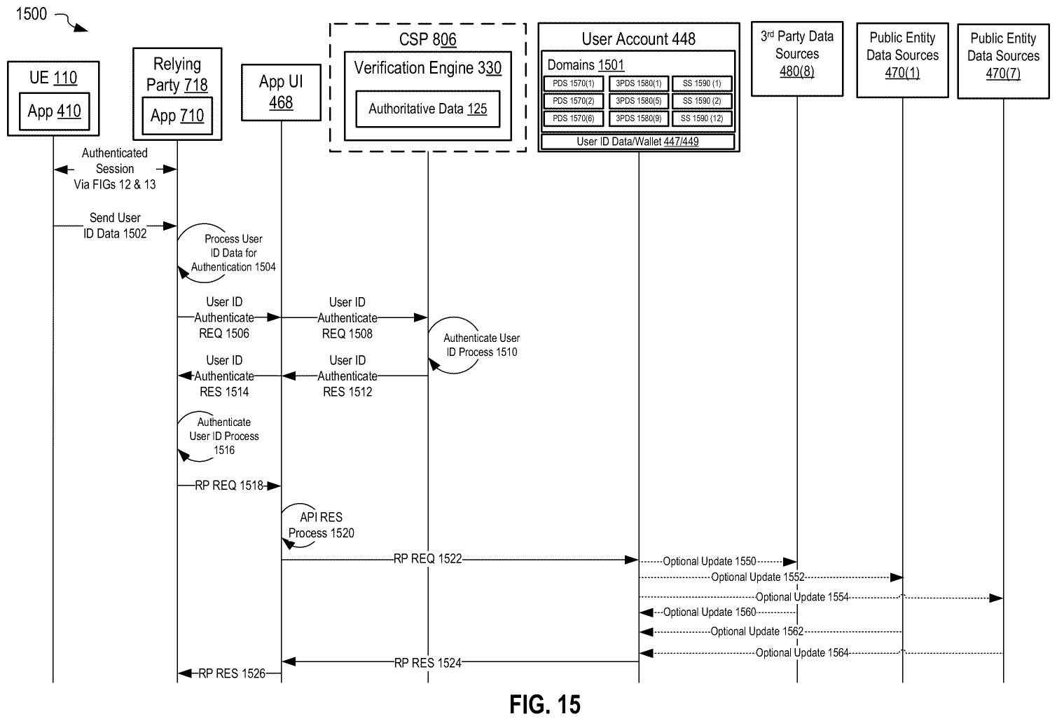

FIG. 15 illustrates a detailed sequence diagram for a relying party request and response process involving user ID data. The communication flow includes a user verification/authentication process for verifying the user is the correct user and to provide functionality such that the relying party can access the correct account. This process involves interactions between the user equipment (UE) 110 and its app 410, relying party 718 and its app 710, application user interface (App UI) 468, verification engine 330, credential service provider (CSP) 806, user account 448, and three disparate data sources 480(8), 470(1), and 470(7) which utilize data and communications protocols in formats different from application service 420 (not shown) and potentially different from each other.

The process begins with an authenticated session between the UE 110 and the relying party 718, established in a manner similar or the same as that shown in FIGS. 12, 13, and 14. In step 1502, UE 110 sends user ID data to the relying party 718. This data may include personal identifying information or other authentication credentials. The relying party 718 then processes this data for authentication in step 1504, which may involve initial validation checks.

Following the initial processing, the relying party 718 initiates a user ID authentication request (step 1506) to the App UI 468. The App UI 468 forwards this request (step 1508) to the verification engine 330, which is part of the CSP 806. The verification engine 330 contains authoritative data 125, which may include official records or verified user information.

In step 1510, the verification engine 330 performs the authenticate user ID process. This may involve comparing the received user ID data against the authoritative data 125 to verify the user's identity. After completing the authentication process, the verification engine 330 sends a user ID authenticate response (step 1512) back to the App UI 468, which then forwards this response (step 1514) to the relying party 718.

Upon receiving the authentication response, the relying party 718 performs its own authenticate user ID process in step 1516. This step may involve additional checks or validations based on the relying party's specific requirements or policies.

After successful authentication, the relying party 718 sends a request (step 1518) to the App UI 468. App UI 468 processes this request in step 1520, which may involve determining which data sources need to be accessed and what permissions are required. The App UI 468 then forwards the request (step 1522) to the user account 448.

The user account 448 contains various domains 1501 and user ID data/wallet 447/449. These domains may represent different categories of user information or access rights. The example of domains 1501 include pointers and/or access to Public Data Source (PDS) 1570(1), 1570(2), PDS 1570(6), 3^{rd} Party Data Source (3PDS) 1580(1), 3PDS 1580(5), 3PDS 1580(9), Services Source (SS) 1590(1), SS 1590(2), and SS 1590(12). At this point, the system may initiate optional update processes to ensure the user account data is current and accurate.

In steps 1550, 1552, and 1554, the user account 448 may send optional update requests to various data sources. These may include third party data sources 480(8), public entity data sources 470(1), and public entity data sources 470(7), respectively. These data sources may contain different types of user-related information, such as financial records, government-issued identification, or other relevant data.

The data sources may respond with optional updates (steps 1560, 1562, and 1564). These updates are processed by the user account 448, potentially using the API 422 (not shown) to normalize the user data for use by the application service, the relying party, and the user as described previously and left out here to simplify the figure and its description. This normalization process may involve standardizing data formats, resolving inconsistencies, and/or aggregating information from multiple sources.

After processing any updates, the user account 448 sends a response (step 1524) back to the App UI 468. The App UI 468 then processes this response and forwards it (step 1526) to the relying party 718. This final response may contain the requested user data, updated as necessary based on the optional update processes.

Throughout this process, the system maintains security and privacy by authenticating both the user and the relying party, and by potentially seeking user consent for data sharing. The optional update steps ensure that the relying party receives the most current and accurate user information available, while the API's normalization function ensures that data from disparate sources can be effectively utilized by all components of the system.

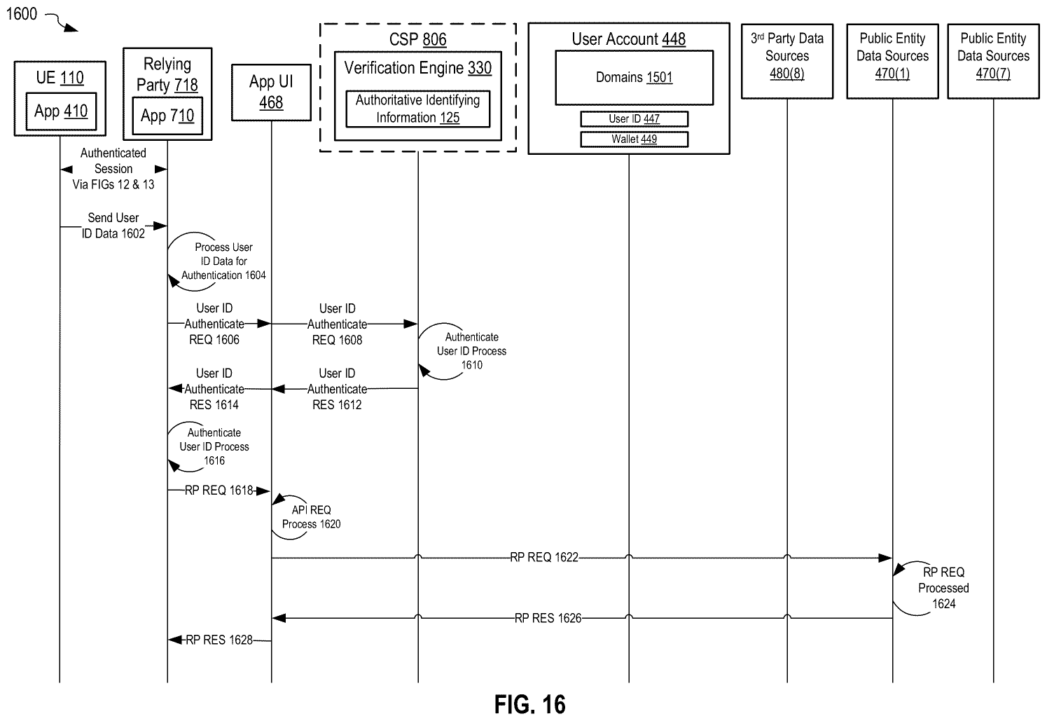

Referring to FIG. 16, the communication flow 1600 illustrates a detailed sequence diagram for a relying party request and response process involving user ID data and accessing user data from only a primary source. This process involves interactions between the user equipment (UE) 110 and its app 410, relying party 718 and its app 710, application user interface (App UI) 468, verification engine 330, credential service provider (CSP) 806, user account 448, and three disparate data sources 480(8), 470(1), and 470(7) which utilize data and communications protocols in formats different from application service 420 (not shown) and potentially different from each other. The communication flow 1600 includes several steps, each involving specific components of the system.

The process begins with an authenticated session between the UE 110 and the relying party 718, established in a manner similar or the same as that shown in FIGS. 12, 13, and 14. In send user ID data step 1602 of communication flow 1600, App 410 sends, via UE 110, user ID data to replying party app 710, received at replying party 718. This data may include personal identifying information or other authentication credentials. The relying party 718 then processes this data for authentication in process user ID data for authentication step 1604, which may involve initial validation checks.

Following the initial processing, the relying party 718 initiates a user ID authentication request (step 1606) to the App UI 468. The App UI 468 forwards this request (step 1608) to the verification engine 330, which is part of the CSP 806. The verification engine 330 contains authoritative data 125, which may include official records or verified user information.

In authenticate user ID process step 1610 of communication flow 1600, the verification engine 330 performs the authenticate user ID process. This may involve comparing the received user ID data against the authoritative data 125 to verify the user's identity. After completing the authentication process, the verification engine 330 sends a user ID authenticate response (step 1612) back to the App UI 468, which then forwards this response (step 1614) to the relying party 718.

Upon receiving the authentication response, the relying party 718 performs its own authenticate user ID process in authenticate user ID process step 1616. This step may involve additional checks or validations based on the relying party's specific requirements or policies.

After successful authentication, the relying party 718 sends a request (step 1618) to the App UI 468. The App UI 468 processes this request in API request process step 1620, which may involve determining which data sources need to be accessed and what permissions are required. The App UI 468 then forwards the request (step 1622) directly to the primary source of information, in this case PEDS 470(1), without accessing the user account 448. App UI 468 may utilize API 422 (not shown) for this process as described elsewhere herein.

PEDS 470(1) processes the relying party request in step 1624. This processing may involve retrieving the requested data from one or more domains, applying any necessary access controls or permissions, and preparing the data for transmission. The processing step may also include checking for any recent updates to the user's data from other related external sources or domains.

After processing the request, PEDS 470(1) sends a relying party response step 1626 back to the App UI 468. This response may contain the requested user data, along with any relevant metadata or access tokens. App UI 468 may then perform additional processing on this response, such as formatting the data, e.g., utilizing API 422, and/or applying any necessary decryption/encryption processes.

Finally, in step 1628, the App UI 468 forwards the relying party response to the relying party 718. This response contains the requested user data, properly formatted and secured for transmission. The relying party 718 can then use this data for its intended purpose, such as verifying the user's identity or providing a specific service.

Throughout this process, the system may implement various security measures to protect the user's data. For example, the responses in steps 1626 and 1628 may be encrypted to prevent unauthorized access. Additionally, the system may log these transactions for auditing purposes or to comply with regulatory requirements.

In some aspects, the user may be notified of this data access and given the option to review or revoke access permissions. This approach ensures transparency and gives users control over their personal information, enhancing the overall security and privacy of the system.

The user account 448 contains various domains 1501 and user ID data/wallet 447/449. These domains may represent different categories of user information or access rights. At this point, the system may initiate optional update processes to ensure the user account data is current and accurate.

Throughout this process, the system maintains security and privacy by authenticating both the user and the relying party, and by potentially seeking user consent for data sharing. The optional update steps ensure that the relying party receives the most current and accurate user information available, while the API's normalization function ensures that data from disparate sources can be effectively utilized by all components of the system.

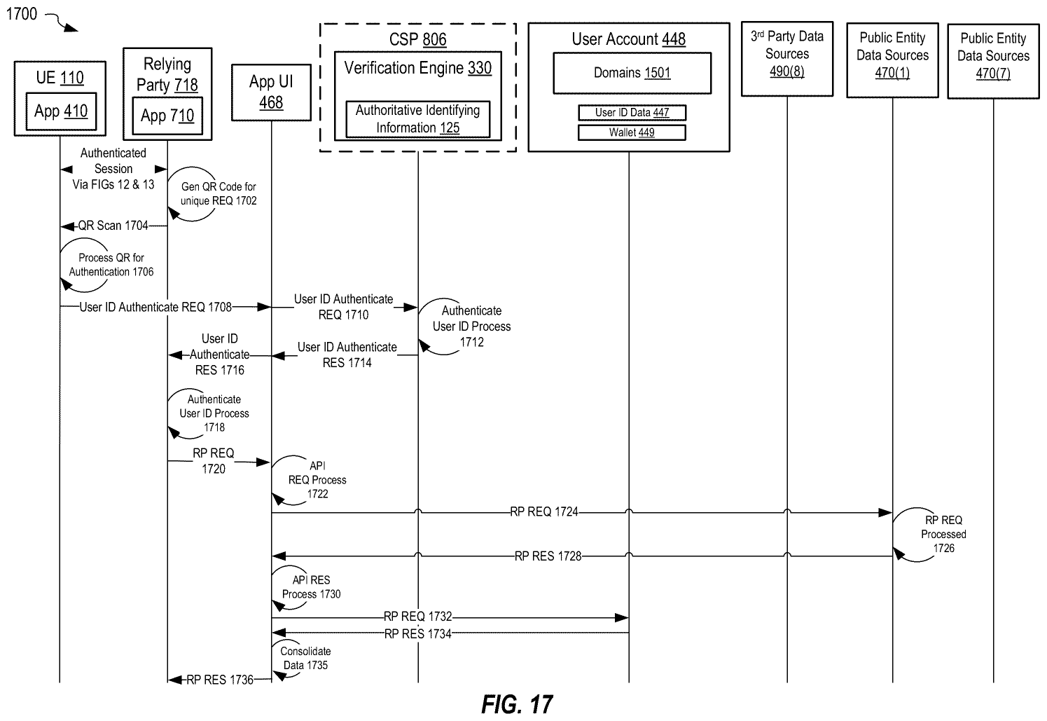

Referring to FIG. 17, a communication flow 1700 illustrates a detailed sequence diagram for a relying party request and response process involving user ID data and accessing user data from both a primary source and a user account. The process involves interactions between elements, systems, and components similar to FIG. 16.

The process begins with an authenticated session between the UE 110 and the relying party 718, established in a manner similar or the same as that shown in FIGS. 12, 13, 14 and discussed in FIGS. 15 and 16. Next, step 1702 generates a unique request, such as but not limited to a QR code, by the relying party 718. The UE 110, which may be a mobile device or a computer used by the individual, scans this QR code in step 1704. The scanned QR code is then processed for authentication in step 1706. This process may involve decoding the QR code to extract the unique request information, which may include a request identifier, a relying party identifier, or other relevant data.

Following the QR code scanning and processing, the UE 110 sends a user ID authentication request to the App UI 468 in step 1708. The App UI 468 forwards this request to the verification engine 330, which is part of the CSP 806, in step 1710. The verification engine 330 contains authoritative data 125, which may include official records or verified user information.

In step 1712, the verification engine 330 performs the authenticate user ID process. This may involve comparing the received user ID data against the authoritative data 125 to verify the user's identity. After completing the authentication process, the verification engine 330 sends a user ID authenticate response back to the App UI 468 in step 1714, which then forwards this response to the relying party 718 in step 1716.

Upon receiving the authentication response, the relying party 718 performs its own authenticate user ID process in step 1718. This step may involve additional checks or validations based on the relying party's specific requirements or policies.

After successful authentication, the relying party 718 sends a request to the App UI 468 in step 1720. The App UI 468 processes this request in step 1722, which may involve determining which data sources need to be accessed and what permissions are required. The App UI 468 then forwards the request to the public entity data source 470(1) in step 1724.

The public entity data source 470(1) processes the request in step 1726 and sends a response back to the App UI 468 in step 1728. The App UI 468 then processes this response in step 1730.

There may be additional requests to the user account 448 to retrieve additional user data in step 1732, with corresponding responses in step 1734. API normalized data from step 1730 and user account data from step 1734 are then consolidated in step 1735. Finally, the APP UI 468 sends the response to the app 710 in relying party device 718 in step 1736, completing the process.

Throughout this process, the system maintains security and privacy by authenticating both the user and the relying party, and by potentially seeking user consent for data sharing. The optional update steps ensure that the relying party receives the most current and accurate user information available, while the API's normalization function ensures that data from disparate sources can be effectively utilized by all components of the system.

1. A method for secure verification of identities, comprising:
receiving a first user's personal identifying information at an application service;
accessing, by the application service via an API, two or more domains within one or more disparate data sources to retrieve official identification information for a first user;
normalizing, by said API, official identification information for the first user received from said disparate data sources for use by said application service;
verifying said personal identifying information against normalized official identification information for the first user from said disparate data sources;
receiving biometric identifying information from the first user using a first user device;
comparing said biometric identifying information with normalized official identification information for the first user from one or more of the disparate data sources; and
determining, based on said comparing, whether to issue a digital identification credential to the first user.

2. The method of claim 1, wherein the official identification information for a first user is official government identification information.

3. The method of claim 1, further comprising:
generating, by a relying party device, a unique request;
receiving the unique request by the first user device; and
processing said unique request for authentication.

4. The method of claim 3, wherein the unique request is a one-time request.

5. The method of claim 3, wherein the unique request is one of a Quick Response (QR) code, an Near-Filed Communication (NFC) message, a Bluetooth (BTE) message, a Uniform Resource Locator (URL), a bar code, an image, and audio file, an Short Message Service (SMS) message, at text message, an Non-Fungible Token (NFT), and a link to a web page.

6. The method of claim 1, wherein said disparate data sources include at least one authoritative government issued ID data repository.

7. The method of claim 1, further comprising:
creating a digital wallet for one or both of the first user and a relying party; and
storing said digital identification credential in the digital wallet.

8. The method of claim 1, further comprising:
receiving a request from a relying party for first user data;
processing said request by said application service;
accessing, via said API, relevant data from one or more disparate data sources based on details of the request and a level of access by the relying party; and
transmitting a response to the relying party including the relevant data.

9. The method of claim 8, further comprising obtaining user consent before accessing the relevant data.

10. The method of claim 1, wherein said normalizing includes one or both of standardizing data formats and resolving inconsistencies between data from different sources.

11. The method of claim 1, further comprising updating said digital identification credential in real-time based on changes in data from one or more disparate data sources.

12. The method of claim 1, wherein said digital identification credential includes at least one of a digital driver license, state identification card, national identification card, a digital passport, and a digital government-issued identification card.

13. The method of claim 1, further comprising establishing an authenticated session between the first user device and a relying party device based on an authentication result.

14. A method for secure verification of identities, comprising:
generating, by a relying party and based on a relying party identity and data requested by the relying party, a unique request;
receiving, by a remote device, the unique request;
combining, at the remote device, the unique request with digital user identity data stored in memory of the remote device to generate a unique request package;
sending, from the remote device, the unique request package to an application user interface of the application service;
authenticating, by a verification engine associated with the application service, relying party identity and the digital user identity;
identifying one or more disparate data sources that hold the data requested in the unique request;
sending the digital user identity or data associated with the digital user identity and the unique request or data associated with the unique request to an API;
forwarding the digital user identity or data associated with the digital user identity and the unique request or data associated with the unique request from the API to the identified one or more disparate data sources to request user specific data associated with the digital user identity;
receiving one or more response from the one or more disparate data sources at the API;
packaging the received one or more responses for the relying party; and
transmitting the packaged received one or more responses to the relying party to satisfy the request.

15. The method of claim 14, wherein the unique request is a QR code.

16. The method of claim 14, wherein receiving the unique request is one of scanning a QR code, receiving a wireless unique request, receiving an optical unique request, and receiving an audio unique request.

17. The method of claim 14, further comprising:
sending a request from the relying party to a user account to update or retrieve additional data; and
receiving a response from the user account with the updated or additional data.

18. The method of claim 14, wherein the unique request contains information specific to the relying party.

19. The method of claim 14, wherein the user ID authentication request includes biometric data.

20. The method of claim 14, wherein the public entity data source is a government database.
